(19) United States
(12) Patent Application Publication
(10) Pub. No.: US 2021/0146655 A1
(43) Pub. Date: May 20, 2021

(54) COMPOSITES COMPRISING CEMENTITIOUS COATINGS INCLUDING FIBERS

(71) Applicant: BORAL IP HOLDINGS (AUSTRALIA) PTY LIMITED, North Sydney (AU)

(72) Inventors: Amitabha KUMAR, San Antonio, TX (US); Cassandra HILL, San Antonio, TX (US); Li Al, San Antonio, TX (US); Russell L. HILL, San Antonio, TX (US)

(73) Assignee: BORAL IP HOLDINGS (AUSTRALIA) PTY LIMITED, North Sydney (AU)

(21) Appl. No.: 17/255,800

(22) PCT Filed: Jun. 27, 2018
(86) PCT No.: PCT/US2018/039811

§ 371 Date: Dec. 23, 2020

(51) Int. Cl. B32B 13/12; B32B 13/02; B32B 27/40; B32B 37/24; B32B 38/00

(52) U.S. Cl. CPC B32B 13/12; B32B 13/02; B32B 27/40; B32B 37/24; B32B 38/00; B32B 2250/03; B32B 2307/546; B32B 2262/101; B32B 2262/08; B32B 2262/0276; B32B 2262/0269; B32B 2262/0253; B32B 2262/065; B32B 2250/40

(57) ABSTRACT

Disclosed herein are organic-inorganic composite materials. Also disclosed herein are organic-inorganic composite materials including polymer substrates with at least one cementitious layer comprising inorganic fibers and organic fibers. Also disclosed herein are organic-inorganic composite materials including polymer substrates with at least one cementitious layer comprising fibers of varying length and diameter. Also disclosed herein are organic-inorganic composite materials including polymer substrates with at least one cementitious layer comprising a plurality of fibers having an average diameter of 7 microns or greater. Also disclosed herein are methods of making and using the same.

### FIELD OF THE DISCLOSURE

This disclosure relates generally to composites comprising organic-inorganic composite materials and related methods. In particular, this disclosure relates to organic-inorganic composites comprising polymer substrates having cementitious coatings with fibers and related methods.

### BACKGROUND

Organic-inorganic composite materials are useful in a variety of applications because of their desirable mechanical properties compared to inorganic materials without organic matter. Desirable properties of organic-inorganic composites can be achieved by using the organic material as a matrix material that acts as a glue with enhanced flexural properties or as a fibrous component providing reinforcement and improved tensile properties. The inorganic material can impart various properties of rigidity, toughness, hardness, optical appearance and interaction with electromagnetic radiation, density, and many other physical and chemical attributes. Improved organic-inorganic composite materials are desired to provide a material or class of materials that are technically superior, capable of manufacture at scale and provide material, and cost benefits to the manufacturers and users.

### SUMMARY

Disclosed herein are organic-inorganic composite materials and methods of making and using the same. In some embodiments, the composite materials comprise a first cementitious layer comprising a first inorganic fiber, a first organic fiber, or a mixture thereof, a second cementitious layer comprising a second inorganic fiber, a second organic fiber, or a mixture thereof, a composite core having a first planar surface and a second planar surface opposite the first planar surface, wherein the first cementitious layer is in physical communication with the first planar surface, and wherein the second cementitious layer is in physical communication with the second planar surface.

In some embodiments, the organic-inorganic composite material comprises a cementitious layer comprising at least two fiber types, wherein at least one of the fiber types comprises a fiber length distribution comprising at least two modes; and a composite core having a first planar surface and formed by a reaction of at least one isocyanate selected from the group consisting of diisocyanates, polyisocyanates and mixtures thereof and at least one polyol in the presence of an inorganic filler, the inorganic filler comprising fly ash in an amount from 5% to 95%, by weight of the composite core; wherein the cementitious layer is in physical communication with the first planar surface of the composite core, and wherein the organic-inorganic composite material has a surface smoother than a comparator organic-inorganic composite material having a cementitious layer comprising a single fiber type.

Also disclosed herein are organic-inorganic composite materials, for instance, an organic-inorganic composite material comprising a cementitious layer comprising (i) a first plurality of fibers, and (ii) a second plurality of fibers, wherein at least one of the first plurality of fibers and the second plurality of fibers comprises a fiber length distribution comprising at least two modes and a fiber diameter distribution comprising at least two modes; and a composite core having a first planar surface; wherein the first cementitious layer is in physical communication with the first planar surface of the composite core.

In some embodiments, the organic-inorganic composite material comprises a cementitious layer comprising (i) a first plurality of fibers, and (ii) a second plurality of fibers wherein at least one of the first plurality of fibers and the second plurality of fibers comprises a fiber length distribution comprising at least two modes and a fiber diameter distribution comprising at least two modes; and a composite core having at least one planar surface and formed by a reaction of at least one isocyanate selected from the group consisting of diisocyanates, polyisocyanates, and mixtures thereof and at least one polyol in the presence of an inorganic filler, the inorganic filler comprising fly ash in an amount of from 5% to 95%, by weight of the composite core; wherein the cementitious layer is in physical communication with the first planar surface of the composite core, and wherein the organic-inorganic composite material has a surface smoother than a comparator organic-inorganic composite material having a cementitious layer comprising a single type of fiber.

Also disclosed herein are organic-inorganic composite materials, for instance, an organic-inorganic composite material comprising a first cementitious layer comprising a first plurality of fibers having an average diameter of 7 microns or greater; a second cementitious layer comprising a second plurality of fibers having an average diameter of 7 microns or greater; and a composite core formed by the reaction of at least one isocyanate selected from the group consisting of diisocyanates, polyisocyanates and mixtures thereof and at least one polyol in the presence of an inorganic filler; wherein the first cementitious layer is in physical communication with the first planar surface, and wherein the second cementitious layer on the organic-inorganic composite material is in physical communication with the second planar surface.

Disclosed herein are methods for preparing an organic-inorganic composite material, the methods comprising contacting a first planar surface of a composite core with a cementitious mixture, and curing the cementitious mixture to form a cementitious layer; wherein the composite core is formed by the reaction of at least one isocyanate selected from the group consisting of diisocyanates, polyisocyanates, and mixtures thereof and at least one polyol in the presence of an inorganic filler, wherein said cementitious mixture comprises at least two fiber types, wherein at least one of the fiber types comprises a fiber length distribution comprising at least two modes; and wherein the cementitious layer on the organic-inorganic composite material has a surface smoother than a comparator organic-inorganic composite material having a cementitious layer comprising a single fiber type.

Also disclosed herein are methods for preparing organic-inorganic composite materials comprising contacting a first planar surface of a composite core with a cementitious mixture, and curing the cementitious mixture to form a cementitious layer; wherein the composite core is formed by the reaction of at least one isocyanate selected from the group consisting of diisocyanates, polyisocyanates, and mixtures thereof and at least one polyol in the presence of an inorganic filler, wherein said cementitious mixture comprises (i) a first plurality of fibers, and (ii) a second plurality of fibers; wherein at least one of the first plurality of fibers and the second plurality of fibers comprise a fiber length distribution comprising at least two modes and a fiber diameter distribution comprising at least two modes, wherein the cementitious layer of the organic-inorganic composite material has a surface smoother than a comparator composite material having a cementitious layer comprising a single fiber type.

Also disclosed herein are methods for preparing organic-inorganic composite materials comprising contacting a first planar surface of a composite core with a cementitious mixture, and curing the cementitious mixture to form a cementitious layer; wherein the composite core is formed by the reaction of at least one isocyanate selected from the group consisting of diisocyanates, polyisocyanates, and mixtures thereof and at least one polyol in the presence of an inorganic filler, wherein said cementitious mixture comprises a plurality of fibers having an average diameter of 7 microns or greater; wherein the cementitious layer of the organic-inorganic composite materials has a surface smoother than a comparator organic-inorganic composite material comprising a plurality of fibers having an average diameter of 6 microns.

### BRIEF DESCRIPTION OF THE DRAWINGS

FIG. 1 depicts an embodiment of an organic-inorganic composite material disclosed herein, not necessarily drawn to scale.

### DETAILED DESCRIPTION

Disclosed herein are organic-inorganic composite materials and methods of making and using the same. Organic-inorganic composite materials can provide for a class of materials with superior flexural properties compared to inorganic materials without organic matter. The superior properties of organic-inorganic composites can be achieved by using the organic material a fibrous component providing reinforcement and improved tensile properties. The inorganic material can impart various properties of rigidity, toughness, hardness, optical appearance and interaction with electromagnetic radiation, density, and/or other physical and chemical attributes. Further, a combination of inorganic and organic components as described herein can provide for a material with surprising flexural and compressive properties for handling, use, and life of the composite material. Cementitious layers in the organic-inorganic composite materials disclosed herein can have sufficient properties to bond with other materials that can be overlaid on the composite material depending on the end use application, which may include mortar for tiling or paints or other materials, including but not limited to decorative pigments, attachments, or other materials. In some embodiments, the organic-inorganic composite materials can comprise cementitious layers with sufficient durability properties to withstand weathering for exterior applications. The organic-inorganic composite materials can have cementitious layers with improved resistance to radiation and/or natural weathering such as UV radiation or water. Thus, a cementitious layer on the surface could act as a barrier for such negative interaction. The cementitious layers can have sufficient durability properties to withstand weathering. Disclosed herein are various organic-inorganic composite materials that can be technically superior, capable of manufacture at scale, and provide material and cost benefits to the manufacturers and users.

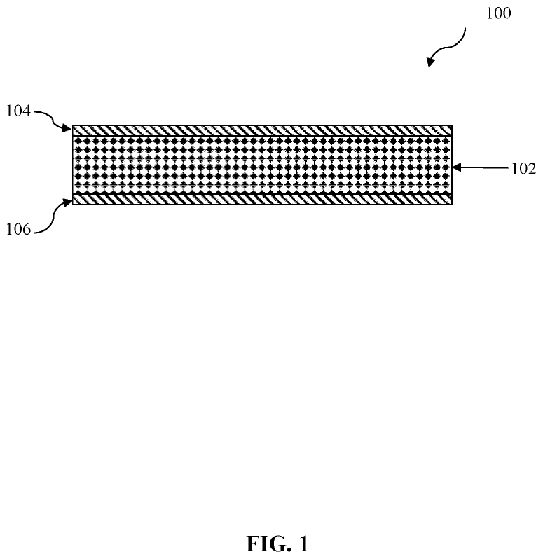

FIG. 1 depicts an embodiment of an organic-inorganic composite material disclosed herein, not necessarily drawn to scale. FIG. 1 depicts composite 100, comprising a polymer substrate 102 with a first cementitious layer 104 and a second cementitious layer 106. In some embodiments, the polymer substrate 102 comprises internal organic reinforcement and/or internal inorganic reinforcement. One or both of the first cementitious layer 104 and second cementitious layer 106 comprises fibers.

The organic-inorganic composite materials disclosed herein can include polymer substrates. The polymer substrate can comprise any polymer capable of being coated with a cementitious layer to provide an organic-inorganic composite material with the desired mechanical, chemical, and/or other properties. In some embodiments, the polymer substrate comprises a polyurethane composite. The polyurethane composites can comprise a polyurethane formed using highly reactive systems such as highly reactive polyols, isocyanates, or both.

Isocyanates suitable for use in the polyurethane composites described herein include one or more monomeric or oligomeric poly- or di-isocyanates. The monomeric or oligomeric poly- or di-isocyanate include aromatic diisocyanates and polyisocyanates. The isocyanates can also be blocked isocyanates or pre-polymer isocyanates. A non-limiting example of a useful diisocyanate is methylene diphenyl diisocyanate (MDI). Useful MDIs can include MDI monomers, MDI oligomers, and mixtures thereof.

Further examples of useful isocyanates can include those having NCO (i.e., the reactive group of an isocyanate) contents ranging from 25% to 35% by weight. Examples of useful isocyanates are found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Suitable examples of aromatic polyisocyanates include 2,4- or 2,6-toluene diisocyanate, including mixtures thereof p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates are formed by the treatment of the isocyanates described herein with a blocking agent (e.g., diethyl malonate, 3,5-dimethylpyrazole, methylethylketoxime, and caprolactam).

The average functionality of isocyanates useful with the composites described herein can be from 1.5 to 5. In some embodiments, the isocyanates have an average functionality of 1.5 or greater (e.g., 1.6 or greater, 1.7 or greater, 1.8 or greater, 1.9 or greater, 2.0 or greater, 2.1 or greater, 2.2 or greater, 2.3 or greater, 2.4 or greater, 2.5 or greater, 2.6 or greater, 2.7 or greater, 2.8 or greater, 2.9 or greater, 3.0 or greater, 3.1 or greater, 3.2 or greater, 3.3 or greater, 3.4 or greater, 3.5 or greater, 3.6 or greater, 3.7 or greater, 3.8 or greater, 3.9 or greater, 4.0 or greater, 4.1 or greater, 4.2 or greater, 4.3 or greater, 4.4 or greater, 4.5 or greater, 4.6 or greater, 4.7 or greater, 4.8 or greater, or 4.9 or greater). In some embodiments, the isocyanates have an average functionality of 5 or less (e.g., 4.9 or less, 4.8 or less, 4.7 or less, 4.6 or less, 4.5 or less, 4.4 or less, 4.3 or less, 4.2 or less, 4.1 or less, 4.0 or less, 3.9 or less, 3.8 or less, 3.7 or less, 3.6 or less, 3.5 or less, 3.4 or less, 3.3 or less, 3.2 or less, 3.1 or less, 3.0 or less, 2.9 or less, 2.8 or less, 2.7 or less, 2.6 or less, 2.5 or less, 2.4. or less, 2.3 or less, 2.2 or less, 2.1 or less, 2.0 or less, 1.9 or less, 1.8 or less, 1.7 or less, or 1.6 or less). In some embodiments, the isocyanates have an average functionality of from 2 to 4.5, from 2.2 to 4, from 2.4 to 3.7, from 2.6 to 3.4, and from 2.8 to 3.2.

In some embodiments, the polyurethane composites include one or more polyols. The one or more polyols for use in the polyurethane composite can include polyester polyols, polyether polyols, or combinations thereof. In some embodiments, the one or more polyols can include 50% or more of one or more highly reactive (i.e., first) polyols. In some embodiments, the one or more polyols can include 55% or greater (e.g., 60% or greater, 65% or greater, 70% or greater, 75% or greater, 80% or greater, 85% or greater, 90% or greater, 95% or greater, or 100%) of one or more highly reactive polyols. In some embodiments, the one or more polyols can include 100% or less (e.g., 100% or less, 95% or less, 90% or less, 85% or less, 80% or less, 75% or less, 70% or less, 65% or less, or 60% or less) of one or more highly reactive polyols. In some embodiments, the one or more polyols can include 55% to 100% (e.g., 55% to 70%, 70% to 85%, 85% to 100%, 55% to 80%, 80% to 100%, 65% to 85%, 75% to 95%) of one or more highly reactive polyols.

In some embodiments, the one or more highly reactive polyols can include polyols having a hydroxyl number of 250 or greater. For example, the hydroxyl number can be 275 or greater, 300 or greater, 325 or greater, 350 or greater, 375 or greater, 400 or greater, 425 or greater, 450 or greater, or 475 or greater. In some embodiments, the one or more highly reactive polyols can include polyols having a hydroxyl number of 500 or less. For example, the hydroxyl number can be 475 or less, 450 or less, 425 or less, 400 or less, 375 or less, 350 or less, 325 or less, 300 or less, or 275 or less. In some embodiments, the one or more highly reactive polyols can include polyols having a hydroxyl number of 250 to 500 (e.g., 275 to 475, 300 to 450, 325 to 425, 300 to 400, 250 to 350, or 350 to 450).

In some embodiments, the one or more highly reactive polyols can include polyols having a primary hydroxyl number of 250 or greater. For example, the primary hydroxyl number can be 275 or greater, 300 or greater, 325 or greater, 350 or greater, 375 or greater, 400 or greater, 425 or greater, 450 or greater, or 475 or greater. In some embodiments, the primary hydroxyl number of 500 or less. For example, the primary hydroxyl number can be 475 or less, 450 or less, 425 or less, 400 or less, 375 or less, 350 or less, 325 or less, 300 or less, 275 or less, 250 or less, or 225 or less. In some embodiments, the primary hydroxyl number is from 250 to 500 (e.g., 275 to 475, 300 to 450, 325 to 425, 300 to 400, 250 to 350, or 350 to 450).

In some embodiments, the one or more highly reactive polyols include a large number of primary hydroxyl groups (e.g., 75% or more) based on the total number of hydroxyl groups in the polyol. In some embodiments, the highly reactive polyols can include 80% or more, 85% or more, 90% or more, 95% or more, or 100% of primary hydroxyl groups. In some embodiments, the highly reactive polyols can include 100% or less, 95% or less, 90% or less, 85% or less, or 80% or less of primary hydroxyl groups. In some embodiments, the highly reactive polyols can include 75% to 100% (e.g., 75% to 85%, 85% to 95%, 80% to 90%) of primary hydroxyl groups. The number of primary hydroxyl groups can be determined using fluorine NMR spectroscopy as described in ASTM D4273-11 (2011), which is hereby incorporated by reference in its entirety.

In some embodiments, the one or more highly reactive polyols can include a Mannich polyol. Mannich polyols are the condensation product of a substituted or unsubstituted phenol, an alkanolamine, and formaldehyde. Mannich polyols can be prepared using methods known in the art. For example, Mannich polyols can be prepared by premixing the phenolic compound with a desired amount of the alkanolamine, and then slowly adding formaldehyde to the mixture at a temperature below the temperature of Novolak formation. At the end of the reaction, water is stripped from the reaction mixture to provide a Mannich base. See, for example, U.S. Pat. No. 4,883,826, which is incorporated herein by reference in its entirety. The Mannich base can then be alkoxylated to provide a Mannich polyol.

The substituted or unsubstituted phenol can include one or more phenolic hydroxyl groups. In certain embodiments, the substituted or unsubstituted phenol includes a single hydroxyl group bound to a carbon in an aromatic ring. The phenol can be substituted with substituents which do not undesirably react under the conditions of the Mannich condensation reaction, a subsequent alkoxylation reaction (if performed), or the preparation of polyurethanes from the final product. Examples of suitable substituents include alkyl (e.g., a C1-C18 alkyl, or a C1-C12 alkyl), aryl, alkoxy, phenoxy, halogen, and nitro groups.

Examples of suitable substituted or unsubstituted phenols that can be used to form Mannich polyols include phenol, o-, p-, or m-cresols, ethylphenol, nonylphenol, dodecylphenol, p-phenylphenol, various bisphenols including 2,2-bis(4-hydroxyphenyl)propane (bisphenol A), β-naphthol, β-hydroxyanthracene, p-chlorophenol, o-bromophenol, 2,6-di chlorophenol, p-nitrophenol, 4- or 2-nitro-6-phenylphenol, 2-nitro-6- or 4-methylphenol, 3,5-dimethylphenol, p-isopropylphenol, 2-bromo-6-cyclohexylphenol, and combinations thereof. In some embodiments, the Mannich polyol is derived from phenol or a monoalkyl phenols (e.g., a para-alkyl phenols). In some embodiments, the Mannich polyol is derived from a substituted or unsubstituted phenol selected from the group consisting of phenol, para-n-nonylphenol, and combinations thereof.

The alkanolamine used to produce the Mannich polyol can include a monoalkanolamine, a dialkanolamine, a trialkanolamine, a tetraalkanolamine, or combinations thereof. Examples of suitable monoalkanolamines include, but are not limited to, methylethanolamine, ethylethanolamine, methylisopropanolamine, ethylisopropanolamine, methyl-2-hydroxybutylamine, phenyl ethanolamine, ethanolamine, isopropanolamine, and combinations thereof. Exemplary dialkanolamines include, but are not limited to, diisopropanolamine, ethanolisopropanolamine, ethanol-2-hydroxybutylamine, isopropanol-2-hydroxybutylamine, isopropanol-2-hydroxyhexylamine, ethanol-2-hydroxyhexylamine, and combinations thereof. Exemplary trialkanolamines include three hydroxy-substituted C1-C12 alkyl groups (e.g., three hydroxy-substituted C1-C6 alkyl groups, or three hydroxy-substituted C1-C6 alkyl groups). Examples of suitable trialkanolamines include triisopropanolamine, triethanolamine, tris(2-hydroxybutylamine, hydroxyethyl di(hydroxypropyl)amine, hydroxypropyl di(hydroxyethyl)amine, tri(hydroxypropyl)amine, or combinations thereof. Exemplary tetraalkanolamines include four hydroxy-substituted C1-C12 alkyl groups (e.g., four hydroxy-substituted C1-C6 alkyl groups, or four hydroxy-substituted C1-C6 alkyl groups). In certain embodiments, the alkanolamine is selected from the group consisting of diethanolamine, diisopropanolamine, and combinations thereof.

Any suitable alkylene oxide or combination of alkylene oxides can be used to form the Mannich polyol. In some embodiments, the alkylene oxide is selected from the group consisting of ethylene oxide, propylene oxide, butylene oxide, and combinations thereof. In some embodiments, the Mannich polyol is alkoxylated to contain from 100% to 80% by weight propylene oxide units and from 0% to 20% by weight ethylene oxide units. In some embodiments, the Mannich polyol is alkoxylated to contain 80% or greater (e.g., 85% or greater, 90% or greater, 95% or greater, or 100%) by weight propylene oxide units. In some embodiments, the Mannich polyol is alkoxylated to contain 20% or less (e.g., 15% or less, 10% or less, 5% or less) by weight ethylene oxide units.

Mannich polyols are known in the art, and include, for example, ethylene and propylene oxide-capped Mannich polyols.

In some embodiments, the one or more first polyols can include an aromatic polyester polyol, an aromatic poly ether polyol, or a combination thereof. In some embodiments, the one or more first polyols include an aromatic polyester polyol.

Examples of highly reactive polyols also include soybean oil based polyols, soybean oil polyols formed using polyethylene terephthalate, polyols based on soybean oil, diethylene glycol and phthallic anhydride, polyether polyols, a 65% bio-based content (using ASTM D6866-06 (2006)) additive based on soybean oil, a sucrose and glycerin-based polyol; and derivatives thereof. For example, the polyol can be a highly reactive aromatic polyester polyol comprising 80% primary hydroxyl groups, a hydroxyl number of 360-380 mg KOH/g, i.e., and a primary hydroxyl number of 288-304 mg KOH/g.

The one or more polyols for use in the polyurethane composites can include one or more plant-based polyols. In some embodiments, the plant-based polyols are highly reactive polyols. The one or more plant-based polyols useful in the polyurethane composites can include polyols containing ester groups that are derived from plant-based fats and oils. Accordingly, the one or more plant-based polyols can contain structural elements of fatty acids and fatty alcohols. Starting materials for the plant-based polyols of the polyurethane component can include fats and/or oils of plant-based origin with preferably unsaturated fatty acid residues. The one or more plant-based polyols useful with the polyurethane composites include, for example, castor oil, coconut oil, corn oil, cottonseed oil, lesquerella oil, linseed oil, olive oil, palm oil, palm kernel oil, peanut oil, sunflower oil, tall oil, and mixtures thereof. In some embodiments, the one or more polyols do not include plant-based polyols.

In some embodiments, the one or more polyols include a less reactive polyol. For example, the polyurethane composite can be produced from one or more less reactive polyols in addition to one or more highly reactive polyols. Less reactive polyols can have lower hydroxyl numbers, lower numbers of primary hydroxyl groups and/or lower primary hydroxyl numbers than the highly reactive polyols. In some embodiments, the less reactive polyols can have hydroxyl numbers of 250 or less, 225 or less, 200 or less, 175 or less, 150 or less, 125 or less, 100 or less, 80 or less, 60 or less, 40 or less, or 20 or less. In some embodiments, the less reactive polyols can have hydroxyl numbers of 225 or greater, 200 or greater, 175 or greater, 150 or greater, 125 or greater, 100 or greater, 80 or greater, 60 or greater, 40 or greater, or 20 or greater. In some embodiments, the less reactive polyols have 50% or less primary hydroxyl groups, 40% or less primary hydroxyl groups, 30% or less primary hydroxyl groups, 20% or less primary hydroxyl groups, or 10% or less primary hydroxyl groups. In some embodiments, the less reactive polyols can have primary hydroxyl numbers of 220 or less, 200 or less, 180 or less, 160 or less, 140 or less, 120 or less, 100 or less, 80 or less, 60 or less, 40 or less, or 20 or less. Suitable less reactive polyols include, but are not limited to, castor oil, plant-based polyols, soybean oil-based polyols, and combinations thereof.

The one or more polyols can include 50% or less of one or more less reactive polyols in addition to the one or more highly reactive polyols. In some embodiments, the one or more polyols can include 45% or less, 40% or less, 35% or less, 30% or less, 25% or less, 20% or less, 15% or less, 10% or less, or 5% or less of one or more less reactive polyols. In some embodiments, the one or more polyols can include 40% or more, 35% or more, 30% or more, 25% or more, 20% or more, 15% or more, 10% or more, or 5% or more, or 1% or more of one or more less reactive polyols. In some embodiments, the one or more polyols includes 0% to 50% (e.g., 0% to 25%, 25% to 50%, 10% to 20%, 20% to 30%, 30% to 40%, 40% to 50%) of one or more less reactive polyols.

The one or more polyol for use in the disclosure can have an average functionality of 1.5 to 8.0, 1.6 to 6.0, 1.8 to 4.0, 2.5 to 3.5, or 2.6 to 3.1. The average hydroxyl number values (as measured in units of mg KOH/g) for the one or more polyol can be 100 to 600, 150 to 550, 200 to 500, 250 to 440, 300 to 415, and 340 to 400. The polyurethane composites can include more than one type of polyol. The one or more polyols can be combined in various percentages, e.g., 15%-40%, 20%-35%, 25%-30%, 15%-25%, 15%-30%, or 20%-40% of a less reactive polyol and 60%-85%, 65%-75%, 75%-85%, 65%-80% of a highly reactive polyol.

The polyurethane composites described herein can include one or more additional isocyanate-reactive monomers in addition to the one or more polyol. The one or more additional isocyanate-reactive monomers can include, for example, amine and optionally hydroxyl groups.

In some embodiments, the one or more additional isocyanate-reactive monomers can include a polyamine. The first isocyanate-reactive monomer can comprise a polyamine. Any suitable polyamine can be used. Suitable polyamines can correspond to the polyols described herein (for example, a polyester polyol or a polyether polyol), with the exception that the terminal hydroxy groups are converted to amino groups, for example by amination or by reacting the hydroxy groups with a diisocyanate and subsequently hydrolyzing the terminal isocyanate group to an amino group. By way of example, the polyamine can be polyether polyamine, such as polyoxyalkylene diamine or polyoxyalkylene triamine. Polyether polyamines are known in the art and can be prepared by methods including those described in U.S. Pat. No. 3,236,895.

In some embodiments, the additional isocyanate-reactive monomer can include an alkanolamine. The alkanolamine can be a dialkanolamine, a trialkanolamine, or a combination thereof. Suitable dialkanolamines include dialkanolamines, which include two hydroxy-substituted C1-C12 alkyl groups (e.g., two hydroxy-substituted C1-C8 alkyl groups, or two hydroxy-substituted C1-C6 alkyl groups). The two hydroxy-substituted alkyl groups can be branched or linear, and can be of identical or different chemical composition. Examples of suitable dialkanolamines include diethanolamine, diisopropanolamine, ethanolisopropanolamine, ethanol-2-hydroxybutylamine, isopropanol-2-hydroxybutylamine, isopropanol-2-hydroxyhexylamine, ethanol-2-hydroxyhexylamine, and combinations thereof. Suitable trialkanolamines include trialkanolamines, which include three hydroxy-substituted C1-C12 alkyl groups (e.g., three hydroxy-substituted C1-C8 alkyl groups, or three hydroxy-substituted C1-C6 alkyl groups). The three hydroxy-substituted alkyl groups can be branched or linear, and can be of identical or different chemical composition. Examples of suitable trialkanolamines include triisopropanolamine (TIPA), triethanolamine, N,N-bis(2-hydroxyethyl)-N-(2-hydroxypropyl)amine (DEIPA), N,N-bis(2-hydroxypropyl)-N-(hydroxyethyl)amine (EDIPA), tris(2-hydroxybutyl)amine, hydroxyethyl di(hydroxypropyl)amine, hydroxypropyl di(hydroxyethyl)amine, tri(hydroxypropyl)amine, hydroxyethyl di(hydroxy-n-butyl)amine, hydroxybutyl di(hydroxypropyl)amine, and combinations thereof.

In some embodiments, the additional isocyanate-reactive monomer can comprise an adduct of an alkanolamine described above with an alkylene oxide. The resulting amine-containing polyols can be referred to as alkylene oxide-capped alkanolamines. Alkylene oxide-capped alkanolamines can be formed by reacting a suitable alkanolamine with a desired number of moles of an alkylene oxide. Any suitable alkylene oxide or combination of alkylene oxides can be used to cap the alkanolamine. In some embodiments, the alkylene oxide is selected from the group consisting of ethylene oxide, propylene oxide, butylene oxide, and combinations thereof. Alkylene oxide-capped alkanolamines are known in the art, and include, for example, propylene oxide-capped triethanolamine.

In some embodiments, the additional isocyanate-reactive monomer can include an alkoxylated polyamine (i.e., alkylene oxide-capped polyamines) derived from a polyamine and an alkylene oxide. Alkoxylated polyamine can be formed by reacting a suitable polyamine with a desired number of moles of an alkylene oxide. Suitable polyamines include monomeric, oligomeric, and polymeric polyamines. In some cases, the polyamines have a molecular weight of 1000 g/mol or less (e.g., 800 g/mol or less, 750 g/mol or less, 500 g/mol or less, 250 g/mol or less, or 200 g/mol or less). In some cases, the polyamines have a molecular weight of 100 g/mol or more (e.g., 750 g/mol or more, 500 g/mol or more, 250 g/mol or more, or 200 g/mol or more). Examples of suitable polyamines that can be used to form alkoxylated polyamines include, but are not limited to, ethylenediamine, 1,3-diaminopropane, putrescine, cadaverine, hexamethylenediamine, 1,2-diaminopropane, o-phenylenediamine, m-phenylenediamine, p-phenylenediamine, spermidine, spermine, norspermidine, toluene diamine, 1,2-propane-diamine, diethylenetriamine, triethylenetetramine, tetraethylene-pentamine (TEPA), pentaethylenehexamine (PEHA), and combinations thereof.

Any suitable alkylene oxide or combination of alkylene oxides can be used to cap the polyamine. In some embodiments, the alkylene oxide is selected from the group consisting of ethylene oxide, propylene oxide, butylene oxide, and combinations thereof. Alkylene oxide-capped polyamines are known in the art, and include, for example, propylene oxide-capped ethylene diamine and ethylene and propylene oxide-capped ethylene diamine.

The additional isocyanate-reactive monomer (when used) can be present in varying amounts relative the one or more polyol used to form the polyurethane. In some embodiments, the additional isocyanate-reactive monomer can be present in an amount of 30% or less, 25% or less, 20% or less, 15% or less, 10% or less, or 5% or less by weight based on the weight of the one or more polyol. In some embodiments, the additional isocyanate-reactive monomer can be present in an amount of 25% or more, 20% or more, 15% or more, 10% or more, or 5% or more by weight based on the weight of the one or more polyol. In some embodiments, the additional isocyanate-reactive monomer can be present in an amount of 0%-30% (e.g., 5%-10%, 10%-15%, 15%-20%, 20%-25%, 25%-30%, 10%-20%, 5%-15%, 15%-25%) by weight based on the weight of the one or more polyol.

In some embodiments, in the polyurethane composites, an isocyanate is reacted with a polyol (and any additional isocyanate-reactive monomers) to produce the polyurethane formulation. In general, the ratio of isocyanate groups to the total isocyanate reactive groups, such as hydroxyl groups, water and amine groups, is in the range of 0.5:1 to 1.5:1, which when multiplied by 100 produces an isocyanate index between 50 and 150. Additionally, the isocyanate index can be from 50 to 100, 60 to 110, 70 to 115, 80 to 120, 90 to 120, 100 to 115, 105 to 110, 120 to 150, 75 to 125. As used herein, an isocyanate may be selected to provide a reduced isocyanate index, which can be reduced without compromising the chemical or mechanical properties of the composite material.

One or more catalysts can be added to facilitate curing and can be used to control the curing time of the polymer substrate. Examples of useful catalysts include, but are not limited to, amine-containing catalysts (such as tetramethylbutanediamine and diethanolamine) and tin-, mercury-, and bismuth-containing catalysts. In some embodiments, 0.01 wt % to 2 wt % catalyst or catalyst system (e.g., 0.025 wt % to 1 wt %, 0.05 wt % to 0.5 wt %, or 0.1 wt % to 0.25 wt %, 0.2 wt % to 0.4 wt %, 0.4 wt % to 0.6 wt %, 0.6 wt % to 0.8 wt %, 1 wt % to 1.2 wt %, 1.2 wt % to 1.4 wt %, 1.4 wt % to 1.6 wt %, 1.8 wt % to 2.0 wt %) can be used based on the weight of the polyurethane composite.

The polyurethane can be present in the polyurethane composite in amounts from 10% to 60% based on the weight of polyurethane composite. For example, the polyurethane can be included in an amount from 14% to 60% or 20% to 50% by weight, based on the weight of the polyurethane composite. In some embodiments, the polyurethane in the polyurethane composites can be present in an amount of 10% or greater, 15% or greater, 20% or greater, 25% or greater, 30% or greater, 35% or greater, 40% or greater, 45% or greater, 50% or greater, or 55% or greater by weight, based on the weight of polyurethane composite. In some embodiments, the polyurethane in the polyurethane composites can be present in an amount of 60% or less, 55% or less, 50% or less, 45% or less, 40% or less, 35% or less, 30% or less, 25% or less, 20% or less, or 15% or less by weight, based on the weight of polyurethane composite.

The polymer substrate can have any density sufficient to, when coupled with the one or more cementitious layers, confer the desired mechanical properties to the organic-inorganic composite material. In some embodiments, the polymer substrate has a density of 1.5 g/cm³ or less (e.g., 1.45 g/cm³ or less, 1.4 g/cm³ or less, 1.35 g/cm³ or less, 1.3 g/cm³ or less, 1.25 g/cm³ or less, 1.2 g/cm³ or less, 1.15 g/cm³ or less, 1.1 g/cm³ or less, 1.05 g/cm³ or less, 1 g/cm³ or less, 0.4 g/cm³ or less, 0.35 g/cm³ or greater, 0.3 g/cm³ or less, 0.25 g/cm³ or greater, 0.2 g/cm³ or less, 0.15 g/cm³ or lesser, or 0.1 g/cm³ or less). In some embodiments, the polymer substrate has a density of 0.1 g/cm³ or greater (e.g., 0.15 g/cm³ or greater, 0.2 g/cm³ or greater, 0.25 g/cm³ or greater, 0.3 g/cm³ or greater, 0.4 g/cm³ or greater, 0.45 g/cm³ or greater, 0.55 g/cm³ or greater, 0.6 g/cm³ or greater, 0.65 g/cm³ or greater, 0.7 g/cm³ or greater, 0.75 g/cm³ or greater, 0.8 g/cm³ or greater, 0.85 g/cm³ or greater, 0.9 g/cm³ or greater, 1 g/cm³ or greater, 1.05 g/cm³ or greater, 1.1 g/cm³ or greater, 1.15 g/cm³ or greater, 1.2 g/cm³ or greater, 1.25 g/cm³ or greater, 1.3 g/cm³ or greater, 1.35 g/cm³ or greater, 1.4 g/cm³ or greater, or 1.45 g/cm³ or greater). In some embodiments, the polymer substrate is a low-density foamed polyurethane composite.

The organic-inorganic composite materials can also comprise one or more cementitious layers. In some embodiments, the organic-inorganic composite material comprises a first cementitious layer on a first surface of the polymer substrate (e.g., cementitious layer 104 on polymer substrate 102). In some embodiments, the organic-inorganic composite material comprises a second cementitious layer on a second surface of the polymer substrate (e.g., cementitious layer 106 on polymer substrate 102). The first and second cementitious layers can be made of the same materials or different materials. The first and second cementitious layers can be the same thickness or different thicknesses. In some embodiments, the organic-inorganic composite material comprises only a first or second cementitious layer. The first and/or second cementitious layer can contain or be derived from hydraulic cement, along with any suitable additives. Non-limiting examples of materials that can be used in the first and/or second cementitious layer include Portland cement, sorrel cement, slag cement, fly ash cement, calcium alumina cement, water-soluble calcium sulfate anhydrite, calcium sulfate α-hemihydrate, calcium sulfate β-hemihydrate, natural, synthetic or chemically modified calcium sulfate hemihydrates, calcium sulfate dihydrate (“gypsum,” “set gypsum,” or “hydrated gypsum”), and mixtures thereof. As used herein, the term “calcium sulfate material” refers to any of the forms of calcium sulfate referenced above.

In some embodiments, the cement used for the first and/or second cementitious layers includes Portland cement, for example ASTM Type I to Type V, high alumina cements, for example, cements with aluminum oxide contents ranging from 25% to 80% by weight of the cement, calcium sulfoaluminate cements with or without belite, calcium disilicate, contents, cements blended with pozzolans such as fly ash, natural trass, dehydrated clays, silica fumes, slags and similar materials, cements blended with limestone, or combinations thereof. In some embodiments, the cement may be present in an amount of 10% or greater (e.g., 20% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, 90% or greater, or 95% or greater) by weight based on 100% by weight of the cementitious layer. In some embodiments, the cement may be present in an amount of 100% or less (e.g., 95% or less, 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less) by weight based on 100% by weight of the cementitious layer.

The cement can be selected from the group consisting of Portland cement, rapid-hardening cement, calcium aluminate cement, calcium sulfoaluminate cement, slag, other specialty type cement, a blend of cements, a blend of pozzolans, and combinations thereof. In some embodiments, the cement can be selected from the group consisting of Portland cement, calcium sulfoaluminate cement, and combinations thereof. The Portland cement can be selected from, for instance, Type I ordinary Portland cement (OPC), Type II OPC, Type III OPC, Type IV OPC, Type V OPC, low alkali Type I OPC, low alkali Type II OPC, low alkali Type III OPC, low alkali Type IV OPC, low alkali Type V OPC, and combinations thereof. In some embodiments, the cement can be a blend of Type I OPC and calcium sulfoaluminate cement and can be present in the cementitious layer in a ratio of Type I OPC to calcium sulfoaluminate cement of from 1:6 to 6:1 (e.g., 1:6 to 1:4, 1:4 to 1:2, 1:2 to 1:1, 1:1 to 2:1, 2:1 to 3:1, 3:1 to 4:1, 4:1 to 5:1, 5:1 to 6:1). In some embodiments, the cement can be a blend of Type I OPC and calcium sulfoaluminate cement and can be present in the cementitious layer in a ratio of Type I OPC to calcium sulfoaluminate cement of 1:6 or greater (e.g., 1:5 or greater, 1:4 or greater, 1:3 or greater, 1:3.5 or greater, 1:3.75 or greater, 1:3.25 or greater, 1:2 or greater, 1:2.5 or greater, 1:2.25 or greater, 1:2.75 or greater, 1:1 or greater, 1:1.5 or greater, 1:1.75 or greater, 1:1.8 or greater, 1:1.25 or greater, 1:1.2 or greater, 2:1 or greater, 2.25:1 or greater, 2.5:1 or greater, 2.75:1 or greater, 3:1 or greater, 3.25:1 or greater, 3.5:1 or greater, 3.75:1 or greater, 4:1 or greater, 4.25:1 or greater, 4.5:1 or greater, 4.75:1 or greater, 5:1 or greater, 5.25:1 or greater, 5.5:1 or greater). In some embodiments, the cement can be a blend of Type I OPC and calcium sulfoaluminate cement and can be present in the cementitious layer in a ratio of Type I OPC to calcium sulfoaluminate cement of 6:1 or less (e.g., 5:75:1 or less, 5.5:1 or less, 5.25:1 or less, 5:1 or less, 4.75:1 or less, 4.5:1 or less, 4.25:1 or less, 4:1 or less, 3.75:1 or less, 3.5:1 or less, 3.25:1 or less, 3:1 or less, 2.75:1 or less, 2.5:1 or less, 2.25:1 or less, 2:1 or less, 1.75:1 or less, 1.5:1 or less, 1.25:1 or less, 1:1 or less, 1:1.25 or less, 1:1.5 or less, 1:1.75 or less, 1:2 or less, 1:2.25 or less, 1:2.5 or less, 1:2.75 or less, 1:3 or less, 1:3.25 or less, 1:3.5 or less, 1:3.75 or less, 1:4 or less, 1:4.25 or less, 1:4.5 or less, 1:4.75 or less, or 1:5 or less). The cementitious layer can, in some embodiments, have a thickness of 25 mm or less (e.g., 20 mm or less, 15 mm or less, 10 mm or less, 5 mm or less). The cementitious layer can, in some embodiments, have a thickness of 2 mm or greater (e.g., 5 mm or greater, 10 mm or greater, 15 mm or greater, 20 mm or greater). In some embodiments, the cementitious layer can have a thickness of from 2 mm to 25 mm (e.g., 2 mm to 5 mm, 5 mm to 10 mm, 10 mm to 15 mm, 15 mm to 20 mm, 20 mm to 25 mm). In some embodiments, the cements may provide early setting, curing and strength gain, and/or may provide slurry properties in aqueous systems that allow uniform application on polymeric surfaces. The cementitious mixture can a rapid-hardening cement, another specialty type cement, or a blend of cements and/or pozzolans.

In some embodiments, the cementitious layer comprises a blend of ordinary Portland cement Type I/II and calcium sulfate material. In some embodiments, the cementitious layer comprises a ratio of Portland cement Type I/II to calcium sulfate material of 1:4 or greater (e.g., 1:3 or greater, 1:3.5 or greater, 1:3.75 or greater, 1:3.25 or greater, 1:2 or greater, 1:2.5 or greater, 1:2.25 or greater, 1:2.75 or greater, 1:1 or greater, 1:1.5 or greater, 1:1.75 or greater, 1:1.8 or greater, 1:1.25 or greater, 1:1.2 or greater, 2:1 or greater, 2.25:1 or greater, 2.5:1 or greater, 2.75:1 or greater, 3:1 or greater, 3.25:1 or greater, 3.5:1 or greater, 3.75:1 or greater). In some embodiments, the cementitious layer comprises a ratio of Portland cement Type I/II to calcium sulfate material of 4:1 or less (e.g., 3.75:1 or less, 3.5:1 or less, 3.25:1 or less, 3:1 or less, 2.75:1 or less, 2.5:1 or less, 2.25:1 or less, 2:1 or less, 1.75:1 or less, 1.5:1 or less, 1.25:1 or less, 1:1 or less, 1:1.25 or less, 1:1.5 or less, 1:1.75 or less, 1:2 or less, 1:2.25 or less, 1:2.5 or less, 1:2.75 or less, 1:3 or less, 1:3.25 or less, 1:3.5 or less, or 1:3.75 or less). In some embodiments, the cementitious layer comprises a ratio of Portland cement Type I/II to calcium sulfate material of 1:4 to 4:1 (e.g., 1:3 to 3.25:1, 1:3.5 to 3.75:1, 1:3.75 to 3.5:1, 1:3.25 to 3:1, 1:2 to 2.75:1, 1:2.5 to 2.5:1, 1:2.25 to 2.25:1, 1:2.75 to 2:1, 1:1 to 1:1.2, 1:1.5 to 1:1.25, 1:1.75 to 1:1.8).

In some embodiments, the first cementitious layer, the second cementitious layer, or a combination thereof comprises 60% or greater (e.g., 65% or greater, 70% or greater, 80% or greater, or 90% or greater) cement, by weight of the first and/or second cementitious layer. In some embodiments, the first cementitious layer, the second cementitious layer, or a combination thereof comprises 95% or less (e.g., 90% or less, 85% or less, 80% or less, 75% or less, 70% or less, 65% or less) cement, by weight of the first and/or second cementitious layer.

In some embodiments, the first cementitious layer, the second cementitious layer, the polymer substrate, or a combination thereof includes additional components. These additional components can be used to modify the properties of the cementitious layers, the polymer substrate, and/or the organic-inorganic composite material. For instance, the first cementitious layer, the second cementitious layer, the polymer substrate, or a combination thereof can comprise inert fillers, flow enhancement agents, flow control agents, agents to impart color or other aspects, dispersing agents, ingredients that control the rate of evaporation or bleeding of water, and/or additives that control density.

In some embodiments, the first cementitious layer, the second cementitious layer, the polymer substrate, or a combination thereof can include a filler. In come embodiments, the first cementitious layer, the second cementitious layer, the polymer substrate, or a combination thereof can include an inorganic filler. Suitable examples of inorganic fillers include, but are not limited to, an ash, ground/recycled glass (e.g., window or bottle glass); milled glass; glass spheres; glass flakes; activated carbon; calcium carbonate; aluminum trihydrate (ATH); silica; sand; ground sand; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; and mixtures thereof. In some embodiments, the inorganic filler includes an ash. The ash can be a coal ash or another type of ash such as those produced by firing fuels including industrial gases, petroleum coke, petroleum products, municipal solid waste, paper sludge, wood, sawdust, refuse derived fuels, switchgrass or other biomass material. The coal ash can be fly ash, bottom ash, or combinations thereof. In some examples, the inorganic filler includes fly ash. Fly ash is produced from the combustion of pulverized coal in electrical power generating plants. In some embodiments, the fly ash is Class C fly ash, Class F fly ash, or a mixture thereof. In some embodiments, the fly ash is produced by coal-fueled power plants. In some embodiments, the inorganic filler consists of or consists essentially of fly ash.

The filler (e.g., inorganic filler) can be present in the first cementitious layer, the second cementitious layer, the polymer substrate, or a combination thereof in amounts from 5% to 95% by weight. Suitable lightweight fillers for use in the polymer composites can include expanded volcanic ash, pumice, expanded perlite, pumicite, expanded vermiculite, expanded clay, foamed glass, hollow plastic particles, hollow inorganic particles, soybean hulls, rice hulls, seeds, seed husks, chopped straw, expanded polystyrene beads, scoria, or a combination thereof. In some examples, the lightweight filler can be expanded perlite. In some examples, the lightweight filler can be expanded clay. In some examples, the lightweight filler can be foamed glass. In some embodiments, the lightweight fillers can be coated with an agent selected from surfactants, bonding agents, pigments, and combinations thereof. In some examples, the lightweight filler can be coated with an aminosilane. In some embodiments, the filler (including, without limitation, fly ash, inorganic fillers, lightweight fillers, or combinations thereof) can be present in amounts from 10% to 90%, 20% to 85%, 35% to 80%, 50% to 80%, or from 50% to 75% by weight. Examples of the amount of filler present in the first cementitious layer, the second cementitious layer, the polymer substrate, or a combination thereof include 5% to 10%, 12% to 15%, 20% to 25%, 30% to 33%, 35% to 37%, 38% to 40%, 41% to 43%, 44% to 46%, 47% to 49%, 50% to 52%, 53% to 55%, 56% to 58%, 59% to 61%, 62% to 64%, 65% to 67%, 68% to 70%, 71% to 73%, 74% to 76%, 77% to 79%, 80% to 82%, 83% to 85%, 85% to 87%, 88% to 90%, or 91% to 95% by weight.

In some embodiments, the first cementitious layer, the second cementitious layer, the polymer substrate, or a combination thereof can include an organic fiber. The organic fiber can be any natural or synthetic fiber, based on organic materials. The organic fiber can improve, for example, the processability and mechanical strength of the polymer composites. The organic fiber can be present in the form of, for example, individual fibers, bundles, strings such as yarns, fabrics, papers, rovings, mats, or tows. In some embodiments, the organic fibers have been debundled.

Suitable examples of organic fibers that can be used in the first cementitious layer, the second cementitious layer, the polymer substrate, or a combination thereof can include polyalkylene fibers, polyester fibers, polyamide fibers, phenol-formaldehyde fibers, polyvinyl chloride fibers, polyacrylic fibers, acrylic polyester fibers, polyurethane fibers, polyacrylonitrile fibers, rayon fibers, cellulose fibers, or combinations thereof. In certain embodiments, the organic fiber can include hemp fibers, sisal fibers, cotton fibers, straw, reeds, or other grasses, jute, bagasse fibers, bamboo fibers, abaca fibers, flax, southern pine fibers, wood fibers, cellulose, saw dust, wood shavings, lint, viscose, leather fibers, rayon, and mixtures thereof. Other suitable organic fiber includes synthetic fibers such as, KEVLAR® (by DuPont), viscose fibers, DRALON® fibers, polyethylene fibers, polyethylene terephthalate fibers, polyethylene naphthalate fibers, polypropylene fibers, polyvinyl alcohol fibers, aramid fibers, or combinations thereof. In some examples, the organic fiber can include polyester fibers. In some examples, the organic fiber can be obtained from a waste material such as from used carpets or other consumer sources. In some embodiments, the organic fiber comprises chopped polyester fiber.

The organic fiber in the first cementitious layer, the second cementitious layer, or a combination thereof can have an average length of from about 0.1 inches to about 10 inches. For example, the organic fiber can have an average length of 0.1 inches or greater (e.g., 0.25 inches or greater, 0.5 inches or greater, 0.75 inches or greater, 1 inches or greater, 1.5 inches or greater, 2 inches or greater, 2.5 inches or greater, 3 inches or greater, 3.5 inches or greater, 4 inches or greater, 4.5 inches or greater, 5 inches or greater, 5.5 inches or greater, 6 inches or greater, 6.5 inches or greater, 7 inches or greater, 7.5 inches or greater, 8 inches or greater, 8.5 inches or greater, 9 inches or greater, 9.5 inches or greater). In some embodiments, the organic fiber can have an average length of 10 inches or less (e.g., 9.5 inches or less, 9 inches or less, 8.5 inches or less, 8 inches or less, 7.5 inches or less, 7 inches or less, 6.5 inches or less, 6 inches or less, 5.5 inches or less, 5 inches or less, 4.5 inches or less, 4 inches or less, 3.5 inches or less, 3 inches or less, 2.5 inches or less, 2 inches or less, 1.5 inches or less, 1 inch or less, 0.75 inches or less, 0.5 inches or less, 0.25 inches or less). In certain embodiments, the organic fiber is present in the polymer composite and has an average length of from 50 microns to 50 mm, 50 microns to 26 mm, 50 microns to 15 mm, 100 microns to 10 mm, 500 microns to 7.5 mm, 1 mm to 7 mm, or 3 mm to 6 mm. In some examples, the organic fiber is present in the polyurethane composite and has an average length of 26 mm or less. In some examples, the organic fiber can have an average length of 100 microns or greater.

In some embodiments, the lengths of the organic fiber in the first cementitious layer, the second cementitious layer, combinations thereof, or polymer composite can be uniform (i.e., the lengths of all the fibers can be within 10% of the average length). In some embodiments, the lengths of the organic fiber in the composite can vary. In some embodiments, the organic fiber comprises a fiber length distribution. A fiber length distribution is a distribution of fibers having an average length within a disclosed range. In some embodiments, the fiber lengths can fall into two modes having an average length within the disclosed range. In some embodiments, the first mode has fibers with an average length of 0.2 inches to 10 inches and the second mode has fibers with an average length of 0.1 inches to 5 inches. The method of determining the fiber length distribution can comprise counting at least 100 fibers at a magnification of at least 5× (e.g., 50×, 250×).

In some embodiments, the organic fibers have a denier of 70 or less (e.g., 60 or less, 50 or less, 40 or less, 30 or less, 20 or less, 15 or less, 10 or less, or 5 or less). In some embodiments, the organic fibers have a denier of 1 or greater (e.g., 2 or greater, 3 or greater, 5 or greater, 10 or greater, 15 or greater, 20 or greater, 30 or greater, 40 or greater, 50 or greater, or 60 or greater). In some embodiments, the organic fibers have a denier of 1-70 (e.g., 1-5, 5-10, 10-20, 20-40, 40-60, 60-70). In some embodiments, the organic fibers have a denier of 70 or less (e.g., 60 or less, 50 or less, 40 or less, 30 or less, 20 or less, 10 or less, 5 or less).

In some embodiments, the organic fiber in the first cementitious layer, the second cementitious layer, or combinations thereof can have an average diameter of 1 micron or more, 2 microns or more, 3 microns or more, 5 microns or more, 7 microns or greater, 8 microns or greater, 9 microns or greater, 10 microns or more, 15 microns or more, 20 microns or more, 25 microns or more, 30 microns or more, 35 microns or more, 40 microns or more, or 45 microns or more. In some embodiments, the organic fiber can have an average diameter of from 1 micron to 100 microns, 3 microns to 100 microns, 3 microns to 90 microns, 3 microns to 85 microns, 3 microns to 80 microns, 3 microns to 75 microns, 3 microns to 50 microns, 5 microns to 100 microns, or 10 microns to 100 microns. In some embodiments, the organic fiber in the polymer substrate can have an average diameter of 100 microns or less. In some embodiments, the organic fiber can have an average diameter of 95 microns or less, 90 microns or less, 85 microns or less, 80 microns or less, 75 microns or less, 70 microns or less, 65 microns or less, 50 microns or less, 45 microns or less, 40 microns or less, 30 microns or less, 25 microns or less, 20 microns or less, 15 microns or less, or 10 microns or less. In some examples, the organic fiber comprises a fiber diameter distribution. A fiber diameter distribution is a distribution of fibers having an average diameter within a disclosed range. In some embodiments, the fiber diameter can fall into two modes having an average diameter within the disclosed range. For example, the fiber diameters can fall into two modes having an average diameter within the disclosed range. In some embodiments, the first mode has fibers with an average diameter of 5 microns to 7.7 microns and the second mode has fibers with an average diameter of 9 microns to 10.1 microns. The method of determining the fiber diameter distribution can comprise counting at least 100 fibers at a magnification of at least 5× (e.g., 50×, 250×).

The organic fiber can be present in the first cementitious layer, the second cementitious layer, the polymer substrate, or a combination thereof in any suitable amount to confer a desirable property to the composite and/or organic-inorganic composite material. In some embodiments, the organic fiber can be present in the composites in amounts of 0.1% or greater, 0.5% or greater, 1% or greater, 1.25% or greater, 1.5% or greater, 2% or greater, 3% or greater, 4% or greater, or 5% or greater by weight, based on the total weight of the composite. In some embodiments, the organic fiber can be present in the composites in amounts of 20% or less, 15% or less, 10% or less, 8% or less, 7.5% or less, 7% or less, 6% or less, or 5% or less by weight, based on the total weight of the first cementitious layer, the second cementitious layer, the polymer substrate, or a combination thereof. In some embodiments, the organic fiber can be present in the polymer substrate in an amount from 0.1% to 25% (e.g., 0.2%-0.3%, 0.3%-0.4% 0.4%-0.5%, 0.5%-0.6%, 0.6%-0.7%, 0.7%-0.8%, 0.8%-0.9%, 0.9%-1%, 1%-2%, 2%-3%, 3%-4%, 4%-5%, 5%-6%, 6%-7%, 7%-8%, 8%-9%, 9%-10%, 10%-11%, 11%-12%, 12%-13%, 13%-14%, 14%-15%, 15%-16%, 16%-17%, 17%-18%, 18%-19%, 19%-20%, 20%-21%, 21%-22%, 22%-23%, 23%-24%, 24%-25%) by weight, based on the total weight of the polymer substrate. For example, the organic fiber can be in amounts from 0.1% to 20%, 0.5% to 15%, 0.5% to 10%, 0.5% to 8%, or 0.25% to 4% by weight, based on the total weight of the polymer substrate. In some embodiments, the organic fiber is present in the polymer substrate or a combination thereof in an effective amount to increase the flexural strength and/or handleability of a polymer substrate having a density of 45 lb/ft³ or less (e.g., 40 lb/ft³ or less, 35 lb/ft³ or less, 30 lb/ft³ or less, 25 lb/ft³ or less, 20 lb/ft³ or less, 15 lb/ft³ or less or 10 lb/ft³ or less), compared to a polymer substrate without the organic fiber. In some embodiments, the organic fiber can be present in the first and/or second cementitious layer in an amount of 0.001% to 0.2% (e.g., 0.0015%-0.002%, 0.002%-0.0025%, 0.0025%-0.003%, 0.003%-0.005%, 0.005%-0.0075%, 0.0075%-0.01%, 0.01%-0.015%, 0.015%-0.0175%) by weight, based on the total weight of the first and/or second cementitious layer.

The first cementitious layer, the second cementitious layer, the polymer substrate, or a combination thereof can include an inorganic fiber. The inorganic fiber can be any natural or synthetic fiber, based on inorganic materials. Inorganic fibers suitable for use with the first cementitious layer, the second cementitious layer, the polymer substrate, or a combination thereof can include glass fibers, basalt fibers, alumina silica fibers, aluminum oxide fibers, silica fibers, carbon fibers, metal fibers, mineral wool fibers such as stone wool, slag wool, or ceramic fiber wool, or combinations thereof. The inorganic fiber can be present in the form of, for example, individual fibers, bundles, strings such as yarns, fabrics, papers, rovings, mats, or tows. In some embodiments, the inorganic fibers have been debundled. In some embodiments, the first cementitious layer, the second cementitious layer, the polymer substrate, or a combination thereof can include a combination of inorganic fibers that break and fibers that do not break when the first cementitious layer, the second cementitious layer, the polymer substrate, or a combination thereof is being formed using processing machinery and/or fractured by external stress.

In some embodiments, the inorganic fiber in the first cementitious layer, the second cementitious layer, the polymer substrate, or a combination thereof can include a plurality of glass fibers. In some embodiments, the inorganic fiber comprises chopped fiberglass. Glass fibers can include fibrous glass such as E-glass, C-glass, S-glass, and AR-glass fibers. In some examples, fire resistant or retardant glass fibers can be included to impart fire resistance or retarding properties to the polymer composites. In some embodiments, the average length of the glass fibers in the first cementitious layer, the second cementitious layer, or a combination thereof can be 0.1 inches or greater, 0.11 inches or greater, 0.12 inches or greater, 0.13 inches or greater, 0.14 inches or greater, 0.15 inches or greater, or 0.16 inches or greater. In some embodiments, the average length of the glass fibers in the polymer substrate can be 50 mm or less, 40 mm or less, 30 mm or less, 20 mm or less, 15 mm or less, 12 mm or less, or 10 mm or less. In some examples, the glass fibers in the first cementitious layer, the second cementitious layer, or a combination thereof can be from 0.1 inches to 0.15 inches in average length. For example, the glass fibers can be from 0.11 inches to 0.14 inches or from 0.12 inches to 0.13 inches in average length. The glass fibers can have any dimension of from 1 micron to 30 microns (e.g., 2 microns-3 microns, 3 microns-4 microns, 4 microns-5 microns, 5 microns-6 microns, 6 microns-7 microns, 7 microns-8 microns, 8 microns-9 microns, 9 microns-10 microns, 10 microns-11 microns, 11 microns-12 microns, 12 microns-13 microns, 13 microns-14 microns, 14 microns-15 microns, 15 microns-16 microns, 16 microns-17 microns, 17 microns-18 microns, 18 microns-19 microns, 19 microns-20 microns, 20 microns-21 microns, 21 microns-22 microns, 22 microns-23 microns, 23 microns-24 microns, 24 microns-25 microns, 25 microns-26 microns, 26 microns-27 microns, 27 microns-28 microns, 28 microns-29 microns) in average diameter. For example, the average diameter of the glass fibers can be 1.5 microns to 30 microns, 3 microns to 20 microns, 4 microns to 18 microns, or 5 microns to 15 microns, 1 micron to 6 microns, 6 microns to 15 microns, 7 microns or greater, 8 microns or greater, 9 microns or greater, 10 microns or greater, 11 microns or greater, 12 microns or greater, 13 microns or greater, 14 microns or greater, 15 microns or greater, or 16 microns or greater in average diameter. The glass fibers can be provided in the first cementitious layer, the second cementitious layer, the polymer substrate, or a combination thereof in a random orientation or can be axially oriented. For example, the fiber length distribution can fall into two modes having an average length within the disclosed range. In some embodiments, the first mode has fibers with an average length of 0.2 inches to 10 inches and the second mode has fibers with an average length of 0.1 inches to 5 inches. For example, the fiber diameters can fall into two modes having an average diameter within the disclosed range. In some embodiments, the first mode has fibers with an average diameter of 5 microns to 7.7 microns and the second mode has fibers with an average diameter of 9 microns to 10.1 microns.

In some embodiments, the organic and/or inorganic fiber comprises fibers of any type or combination of types according to Table 1 below. In some embodiments, the inorganic fiber comprises fibers of type D. In some embodiments, the inorganic fiber comprises fibers of type E. In some embodiments, the inorganic fiber comprises fibers of type DE (diameter, for example, of 5.0 to 7.6 microns). In some embodiments, the inorganic fiber comprises fibers of type G. In some embodiments, the inorganic fiber comprises fibers of type M. In some embodiments, the first and second fiber types combined are present in an amount of 0.05% wt. to 5% wt. of the cementitious layer (e.g. 0.1% wt. to 4.5% wt., 0.2 to 4% wt., 0.3% wt. to 3.5% wt., 0.35% wt. to 3% wt., 0.15% wt. to 1.2% wt., 1% wt. to 1.5% wt., 2% wt. to 4% wt.).

TABLE 1
Filament/Fiber Diameter Types

| | Filament/Fiber Diameter, | Filament/Fiber Diameter, |
|---|---|---|
| Alphabet | microns | 10⁻⁴ in. |
| AA | 0.8-1.2 | 0.3-0.5 |
| A | 1.2-2.5 | 0.5-1.0 |
| B | 2.5-3.8 | 1.0-1.5 |
| C | 3.8-5.0 | 1.5-2.0 |
| D | 5.0-6.4 | 2.0-2.5 |
| E | 6.4-7.6 | 2.0-3.0 |
| F | 7.6-9.0 | 3.0-3.5 |
| G | 9.0-10.2 | 3.5-4.0 |
| H | 10.2-11.4 | 4.0-4.5 |
| J | 11.4-12.7 | 4.5-5.0 |
| K | 12.7-14.0 | 5.0-5.5 |
| L | 14.0-15.2 | 5.5-6.0 |
| M | 15.2-16.5 | 6.0-6.5 |
| N | 16.5-17.8 | 6.5-7.0 |
| P | 17.8-19.0 | 7.0-7.5 |
| Q | 19.0-20.3 | 7.5-8.0 |
| R | 20.3-21.96 | 8.0-8.5 |
| S | 21.6-22.9 | 8.5-9.0 |
| T | 22.9-24.1 | 9.0-9.5 |
| U | 24.1-25.4 | 9.5-10 |

The inorganic fiber, when used, can be present in the polymer substrate in an amount from 0.1% to 25% (e.g., 0.2%-0.4%, 0.5%-0.7%, 0.8%-1%, 2%-4%, 5%-7%, 8%-10%, 11%-13%, 14%-16%, 17%-19%, 20%-22%, 23%-25%) by weight, based on the total weight of the polymer substrate. For example, the inorganic fiber can be in amounts from 0.25% to 20%, 0.5% to 15%, 0.5% to 10%, 0.5% to 8%, or 0.25% to 4% by weight, based on the total weight of the polymer substrate. In some embodiments, the inorganic fiber is present in the polymer substrate or a combination thereof in an effective amount to increase the flexural strength and/or handleability of a polymer substrate having a density of 45 lb/ft³ or less (e.g., 40 lb/ft³ or less, 35 lb/ft³ or less, 30 lb/ft³ or less, 25 lb/ft³ or less, 20 lb/ft³ or less, 15 lb/ft³ or less or 10 lb/ft³ or less), compared to a polymer substrate without the inorganic fiber. In some embodiments, the inorganic fiber can be present in the first and/or second cementitious layer in an amount of 0.001% or greater (e.g., 0.2% or greater, 0.4% or greater, 0.6% or greater, 0.8% or greater, 1% or greater, 2% or greater, 3% or greater, 4% or greater, 5% or greater, 6% or greater, 7% or greater, 8% or greater, 9% or greater) by weight, based on the total weight of the first and/or second cementitious layer. In some embodiments, the inorganic fiber can be present in the first and/or second cementitious layer in an amount of 10% or less (e.g., 9% or less, 8% or less, 7% or less, 6% or less, 5% or less, 4% or less, 3% or less, 2% or less, 1% or less, 0.8% or less, 0.6% or less, 0.4% or less, 0.2% or less) by weight, based on the total weight of the first and/or second cementitious layer.

In some embodiments, the inorganic fibers have a denier of 70 or less (e.g., 60 or less, 50 or less, 40 or less, 30 or less, 20 or less, 15 or less, 10 or less, or 5 or less). In some embodiments, the inorganic fibers have a denier of 1 or greater (e.g., 2 or greater, 3 or greater, 5 or greater, 10 or greater, 15 or greater, 20 or greater, 30 or greater, 40 or greater, 50 or greater, or 60 or greater). In some embodiments, the inorganic fibers have a denier of 1-70 (e.g., 1-5, 5-10, 10-20, 20-40, 40-60, 60-70).

The weight ratio of the inorganic fiber to the organic fiber can be 1:1 or greater. In some embodiments, the weight ratio of the inorganic fiber to the organic fiber can be 1:1 or greater, 1.25:1 or greater, 1.5:1 or greater, 1.75:1 or greater, 2:1 or greater, 2.25:1 or greater, 2.5:1 or greater, 2.75:1 or greater, 3:1 or greater, 3.5:1 or greater, 4:1 or greater, 5:1 or greater, 6:1 or greater, 7:1 or greater, 8:1 or greater, 9:1 or greater, 10:1 or greater, or 15:1 or greater. In some embodiments, the weight ratio of the inorganic fiber to the organic fiber can be 20:1 or less, 18:1 or less, 15:1 or less, 12:1 or less, 10:1 or less, 9:1 or less, 8:1 or less, 7:1 or less, 6:1 or less, 5:1 or less, 4:1 or less, 3:1 or less, 2.5:1 or less, 2:1 or less, 1.75:1 or less, 1.5:1 or less, or 1.25:1 or less. For example, the weight ratio of the inorganic fiber to the organic fiber can be from 1:1 to 20:1, 1:1 to 15:1, 1:1 to 10:1, 1:1 to 9:1, 1:1 to 8:1, 1:1 to 7:1, 1.5:1 to 6:1, or 2:1 to 5:1. For example, the first and/or second cementitious layers comprise organic and inorganic fibers, wherein the fiber diameter distribution can fall into two modes having an average diameter within the disclosed range. In some embodiments, the first mode has fibers with an average diameter of 5 microns to 7.7 microns and the second mode has fibers with an average diameter of 9 microns to 10.1 microns. In some embodiments, the first and/or second cementitious layers comprise organic and inorganic fibers, wherein the fiber length distributions can fall into two modes having an average length within the disclosed herein range. In some embodiments, the first mode has fibers with an average length of 0.2 inches to 10 inches and the second mode has fibers with an average length of 0.01 inches to 5 inches. In some embodiments, the inorganic and/or organic fibers have diameter and length that are bi-modal.

In some embodiments, the organic fiber, inorganic fiber, and/or inorganic filler such as fly ash can be coated with a composition to modify their reactivity. For example, the organic fiber, inorganic fiber, and/or inorganic filler can be coated with a sizing agent such as a coupling agent (compatibilizer). In some embodiments, the organic fiber, inorganic fiber, and/or the inorganic filler (e.g., fly ash) can be coated with a composition for promoting adhesion. U.S. Pat. No. 5,064,876 to Hamada et al. and U.S. Pat. No. 5,082,738 to Swofford, for example, disclose compositions for promoting adhesion. U.S. Pat. No. 4,062,999 to Kondo et al. and U.S. Pat. No. 6,602,379 to Li et al. describe suitable aminosilane compounds for coating fibers. In some embodiments, the organic fiber, inorganic fiber, and/or inorganic filler are surface coated with a composition comprising a silane compound such as aminosilane. In some embodiments, the organic fiber, inorganic fiber, and/or inorganic filler are surface coated with a composition comprising an oil, starch, or a combination thereof. In some embodiments, the first cementitious layer, the second cementitious layer, the polymer substrate, or a combination thereof can include a combination of coated and uncoated fibers and/or inorganic filler.

The first cementitious layer, the second cementitious layer, the polymer substrate, or a combination thereof described herein can comprise additional materials. The additional materials can include an organic filler, such as a recycled polymeric material. Suitable examples include pulverized polymeric foam or recycled rubber material. Additional components useful with the polymer composites can include foaming agents, blowing agents, surfactants, chain-extenders, crosslinkers, coupling agents, UV stabilizers, fire retardants, antimicrobials, antioxidants, and pigments. For example, the organic fiber, inorganic fiber, and/or inorganic filler can be coated with a surfactant, bonding agent, pigment, or combinations thereof. Though the use of such components is well known to those of skill in the art, some of these additional additives are further described herein.

Chemical foaming agents can include azodicarbonamides and other materials that react at the reaction temperature to form gases such as carbon dioxide. Water is an exemplary foaming agent that reacts with isocyanate to yield carbon dioxide. The presence of water as an added component or in the filler also can result in the formation of polyurea bonds through the reaction of the water and isocyanate. In some embodiments, water may be present in the mixture used to produce the first cementitious layer, the second cementitious layer, the polymer substrate, or a combination thereof in an amount of from greater than 0% to 5% by weight or less, based on the weight of the mixture. In some embodiments, water can be present in a range of 0.02% to 4%, 0.05% to 3%, 0.1% to 2%, or 0.2% to 1% by weight, based on the weight of the mixture. In some embodiments, the mixture used to produce the first cementitious layer, the second cementitious layer, the polymer substrate, or a combination thereof includes less than 0.5% by weight water.

Surfactants can be used as wetting agents and to assist in mixing and dispersing the materials in a composite. Surfactants can also stabilize and control the size of bubbles formed during the foaming event and the resultant cell structure. Surfactants can be used, for example, in amounts below about 0.5 wt % based on the total weight of the mixture. Examples of surfactants useful with the polyurethanes described herein include anionic, non-ionic and cationic surfactants.

Low molecular weight reactants such as chain-extenders and/or crosslinkers can be included in the polymer substrate described herein. These reactants can help, for instance, the polyurethane system to distribute and contain the organic fiber, inorganic fiber, and/or inorganic filler within the polymer composite. Chain-extenders are difunctional molecules, such as diols or diamines, that can polymerize to lengthen the urethane polymer chains. Examples of chain-extenders include ethylene glycol; 1,4-butanediol; ethylene diamine, 4,4′-methylenebis(2-chloroaniline) (MBOCA); diethyltoluene diamine (DETDA); and aromatic diamines. Crosslinkers are tri- or greater functional molecules that can integrate into a polymer chain through two functionalities and provide one or more further functionalities (i.e., linkage sites) to crosslink to additional polymer chains.

Examples of crosslinkers include, but are not limited to, glycerin, trimethylolpropane, sorbitol, diethanolamine, and triethanolamine. In some composites, a crosslinker or chain-extender may be used to replace at least a portion of the one or more polyol in the polymer substrate. For example, the polymer composite can be formed by the reaction of an isocyanate, a polyol, and a crosslinker.

Coupling agents and other surface treatments such as viscosity reducers, flow control agents, or dispersing agents can be added directly to the filler or fiber, or incorporated before, during, and/or after the mixing and reaction of the composite materials. Coupling agents can allow higher filler loadings of the inorganic filler such as fly ash, organic fiber, and/or inorganic fiber, and may be used in small quantities. For example, the organic-inorganic composite material, the first/second cementitious layer, and/or the polymer substrate can comprise about 0.01 wt % to about 0.5 wt % of a coupling agent, by weight of the organic-inorganic composite material, the first/second cementitious layer, and/or the polymer substrate.

Ultraviolet light stabilizers, such as UV absorbers, and/or fire retardants can be added to the organic-inorganic composite material, the first cementitious layer, the second cementitious layer, and/or the polymer substrate described herein. Examples of UV light stabilizers include, but are not limited to, hindered amine type stabilizers and opaque pigments like carbon black powder. Fire retardants can be included to increase the flame or fire resistance. Antimicrobials can be used to limit the growth of mildew and other organisms. Antioxidants, such as phenolic antioxidants, can also be added. Antioxidants provide increased UV protection, as well as thermal oxidation protection.

Pigments or dyes can optionally be added to the organic-inorganic composite material, the first cementitious layer, the second cementitious layer, and/or the polymer substrate. An example of a pigment is iron oxide, which can be added in amounts ranging from about 2 wt % to about 7 wt %, based on the total weight of organic-inorganic composite material, the first cementitious layer, the second cementitious layer, and/or the polymer substrate.

Other additives can be used the organic-inorganic composite material, the first cementitious layer, the second cementitious layer, and/or the polymer substrate to impart any desired qualities (e.g., aesthetic qualities, mechanical properties, processability properties, cost savings, etc.). In some embodiments, methylcellulose and/or hydroxypropyl methylcellulose can be added as a viscosity modifying agent.

In some embodiments, the composite 100 can include a first cementitious layer 104 comprising a first inorganic fiber, a first organic fiber, or a mixture thereof, a second cementitious layer 106 comprising a second inorganic fiber, a second organic fiber, or a mixture thereof, and a composite core having a first planar surface and a second planar surface opposite the first planar surface. In some embodiments, the first cementitious layer is in physical communication with the first planar surface of the composite core. In some embodiments, the second cementitious layer is in physical communication with the second planar surface of the composite core. In some embodiments, the first cementitious layer is in partial physical communication with the first planar surface of the composite core. In some embodiments, the second cementitious layer is in partial physical communication with the second planar surface of the composite core. In some embodiments, the first cementitious layer is in partial physical communication with the first planar surface of the composite core and the second cementitious layer is in physical communication with the second planar surface of the composite core.

In some embodiments, the organic-inorganic composite material 100 can include a first cementitious layer and/or a second cementitious layer comprising at least two fiber types and a composite core having a first planar surface and a second planar surface opposite the first planar surface. In some embodiments, the second cementitious layer is in physical communication with the second planar surface of the composite core. In some embodiments, at least one of the fiber types can comprise a fiber length distribution comprising at least two modes. In some embodiments, the first fiber type comprises ASTM D578 (2011) type D/E fibers and a second fiber type comprises ASTM D578 (2011) type G fibers. In some embodiments, the first fiber type and the second fiber type are present at a weight ratio of from 2:1 to 4:1. In some embodiments, the composite core can be formed by a reaction of at least one isocyanate selected from the group consisting of diisocyanates, polyisocyanates and mixtures thereof and at least one polyol in the presence of an inorganic filler, the inorganic filler comprising fly ash from 5% to 95% (e.g., 10% or greater, 20% or greater, 30% or greater, 40% or greater, 50% or greater, 60% or greater, 70% or greater, 80% or greater, 10% to 90%, 20% to 60%, 30% to 50%, 40% to 80%, 50% to 70%, 60% to 90%) by weight of the composite core, the composite material having a surface smoother than a comparator composite material having a cementitious layer comprising a single fiber type. In some embodiments, the organic-inorganic composite material has a surface from 10 percent to 85 percent smoother (e.g., a lower average roughness, Ra) than a comparator organic-inorganic composite material having a cementitious layer comprising a single fiber type. The comparator comprises a composite material comprising glass fibers 0.25 inches in length. In some embodiments, the organic-inorganic composite material has a surface 10% or greater (e.g., 20% or greater, 30% or greater, 40% or greater, 50% or greater, 60% or greater, 70% or greater, 80% or greater) smoother than a comparator organic-inorganic composite material having a cementitious layer comprising a single fiber type. In some embodiments, the organic-inorganic composite material has a surface 85% or less (e.g., 80% or less, 75% or less, 65% or less, 55% or less, 45% or less, 35% or less, 25% or less, 15% or less) smoother than a comparator organic-inorganic composite material having a cementitious layer comprising a single fiber type. In some embodiments, the organic-inorganic composite material has a surface from 60 to 70 percent smoother than a comparator organic-inorganic composite material having a cementitious layer comprising a single fiber type.

An organic-inorganic composite material comprising a cementitious layer comprising (i) a first plurality of fibers, and (ii) a second plurality of fibers wherein at least one of the first plurality of fibers and the second plurality of fibers comprise a fiber length distribution comprising at least two modes and a fiber diameter distribution comprising at least two modes; and a composite core having a first planar surface; wherein the first cementitious layer is in physical communication with the first planar surface of the composite core.

In some embodiments, an organic-inorganic composite material includes a polyurethane composite core having at least one planar surface, a first cementitious layer and/or a second cementitious layer, the first cementitious layer in physical communication with the first planar surface and including a first plurality of fibers having an average diameter of from 5.0 microns to 7.6 microns and an average length of 0.20 inches to 10 inches. In some embodiments, the organic-inorganic composite material can further include a second plurality of fibers having an average diameter of from 9.0 microns to 10.2 microns and an average length of 0.1 inches to 5 inches, the first plurality of fibers and the second plurality of fibers present at a weight ratio of from 2:1 to 4:1. In some embodiments, the composite core can be formed by a reaction of at least one isocyanate selected from the group consisting of diisocyanates, polyisocyanates and mixtures thereof and at least one polyol in the presence of an inorganic filler, the inorganic filler comprising fly ash in an amount of from 5% to 95%, by weight of the composite core, the organic-inorganic composite material having a surface smoother than a comparator organic-inorganic composite material having a cementitious layer comprising a single type of fiber.

In some embodiments, an organic-inorganic composite material includes a composite core having a first planar surface and a second planar surface, a first cementitious layer and/or second cementitious layer including a plurality of fibers having an average diameter of 7 microns or greater (e.g., 8 microns or greater, 9 microns or greater, 10 microns or greater, 11 microns or greater, 12 microns or greater). In some embodiments, the composite core can be formed by the reaction of at least one isocyanate selected from the group consisting of diisocyanates, polyisocyanates, and mixtures thereof and at least one polyol in the presence of an inorganic filler. In some embodiments, the first cementitious layer is in physical communication with the first planar surface of the composite core. In some embodiments, the second cementitious layer is in physical communication with the second planar surface of the composite core. In some embodiments, the first and second cementitious layers are in physical communication with each other. For example, the first cementitious layer can be in physical communication with the composite core, and the second cementitious layer can be layered on top of the first cementitious layer. In some embodiments, more than two cementitious layers are used in the organic-inorganic composite material (e.g., 3 layers, 4 layers, 5 layers, 6 layers).

In some embodiments, an organic-inorganic composite material includes a composite core having a first planar surface and a second planar surface, a first cementitious layer including a first plurality of fibers having an average diameter of 7 microns or greater and/or a second cementitious layer comprising a second plurality of fibers having an average diameter of 7 microns or greater. In some embodiments, the composite core can be formed by the reaction of at least one isocyanate selected from the group consisting of diisocyanates, polyisocyanates and mixtures thereof and at least one polyol in the presence of an inorganic filler. In some embodiments, the first cementitious layer is in physical communication with the first planar surface of the composite core. In some embodiments, the second cementitious layer is in physical communication with the second planar surface of the composite core.

The organic-inorganic composite materials can be of any density to achieve the desired properties (e.g., mechanical properties, cost, appearance, durability, etc.). In some embodiments, the organic-inorganic composite materials can have a density of 0.1 g/cm³ or more (e.g., 0.5 g/cm³ or more, 0.4 g/cm³ or more, 0.3 g/cm³ or more, 0.2 g/cm³ or more).

The organic-inorganic composite materials can have any thickness to achieve the desired properties (e.g., mechanical properties, durability, cost, appearance, etc.). The thickness of the polymer substrate can be, for instance, 0.1 to 10 inches, 0.2 to 5 inches, 0.3 to 3 inches.

Methods of preparing organic-inorganic composite materials comprising polymer substrates coated with cementitious mixtures are described herein. In some embodiments, methods for preparing organic-inorganic composite materials can comprise contacting a first planar surface of the composite core with a cementitious mixture. In some embodiments, the methods can further comprise curing the cementitious mixture to form a cementitious layer. In some embodiments, the cementitious mixture can comprise at least two fiber types, wherein at least one of the fiber types can comprise a fiber length distribution comprising at least two modes. In some embodiments, the cementitious mixture can comprise a first plurality of fibers, and a second plurality of fibers, wherein at least one of the first plurality of fibers and the second plurality of fibers comprise a fiber length distribution comprising at least two modes and a fiber diameter distribution comprising at least two modes. In some embodiments, the cementitious mixture can comprise a plurality of fibers having an average diameter of 7 microns or greater. In some embodiments, the method can further comprise contacting the cementitious mixture with a smoothening edge and spreading the cementitious mixture in a layer having a thickness from 2 mm to 25 mm (e.g., 4 mm to 20 mm, 6 mm to 15 mm, 8 mm to 10 mm) before curing the cementitious mixture. In some embodiments, the smoothening edge can be a doctor blade.

The application of the cementitious layers with a fibrous component can require proper workability parameter at the initial stage of application followed by hardening at subsequent stages for additional processing. It can also be important for the cement composition to set quickly and achieve final properties to reduce inventory time between forming the product and final end use. The final product can provide, for instance, flexural strength and modulus to the composite.

In some embodiments, the composite core can be a polyurethane composite core. The polyurethane composites can be formed by the reaction of one or more isocyanate, selected from the group consisting of diisocyanates, polyisocyanates, and mixtures thereof, and one or more polyol, in the presence of an organic fiber and an inorganic filler. An inorganic fiber and/or a catalyst can also be present in the reaction mixture. In some embodiments, the polyurethane composite can be produced by mixing the one or more isocyanates, the one or more polyols, the organic fiber, and the inorganic filler, in a mixing apparatus such as a high-speed mixer or an extruder. In some embodiments, mixing can be conducted in an extruder.

The materials can be added in any suitable order. For example, in some embodiments, the mixing stage of the method used to prepare the polyurethane composite can include: (1) mixing the polyol, the organic fiber, and inorganic filler; (2) mixing the isocyanate with the polyol, the organic fiber, and inorganic filler; and optionally (3) mixing the catalyst with the isocyanate, the polyol, the organic fiber, and the inorganic filler. The inorganic fiber can be added at the same time as the organic fiber and inorganic filler, or can be added before, during, or after stage (2) or (3).

The polyurethane composite mixture can be blended in any suitable manner to obtain a homogeneous or heterogeneous blend of the one or more isocyanate, one or more polyol, inorganic filler, organic fiber, inorganic fiber, and catalyst. An ultrasonic device can be used for enhanced mixing and/or wetting of the various components of the composite. The ultrasonic device produces an ultrasound of a certain frequency that can be varied during the mixing and/or extrusion process. The ultrasonic device useful in the preparation of composite materials described herein can be attached to or adjacent to an extruder and/or mixer. For example, the ultrasonic device can be attached to a die or nozzle or to the port of an extruder or mixer. An ultrasonic device may provide de-aeration of undesired gas bubbles and better mixing for the other components, such as blowing agents, surfactants, and catalysts.

The mixture can then be extruded into a mold cavity of a mold, the mold cavity formed by at least an interior mold surface. The mold can be a continuous forming system such as a belt molding system or can include individual batch molds. The belt molding system can include a mold cavity formed at least in part by opposing surfaces of two opposed belts. A molded article can then be formed followed by removal of the article from the mold.

Methods of making cementitious mixtures with fibers are also disclosed herein. In some embodiments, the cementitious mixture with fibers is made by dispersing fibers (of the various types, ratios, properties, etc. disclosed herein) into the cementitious mixture by mixing for an amount of time at a temperature and a pressure. In some embodiments, the cementitious layer is hardened and joined to the polymer substrate by adhesion. In some embodiments, the cementitious layer is hardened and joined to the polymer substrate by mechanical structures (e.g., nails, screws). In some embodiments, the cementitious layers, including the first cementitious layer and the second cementitious layer, are applied to the polymer substrate in slurry form. The slurry can be applied by pouring, spraying, pumping, squeezing or a combination thereof the mixture of components on to the surface and may be applied as a single layer or multiple layers, simultaneously or at various time intervals. In some embodiments, the same cementitious mixture is applied to both sides of a polymer substrate. In some embodiments, different cementitious mixtures are applied to each side of the polymer substrate. In some embodiments, different cementitious mixtures are applied in different layers on the same side of the polymer substrate. The slurry can be cured by placing the coated boards in air atmosphere or humid atmosphere, with or without heat, pressure or both. In some embodiments, the fibers can be added to the cementitious layer before, during, after coating (e.g., via spraying to distribute the fibers during or after coating), or a combination thereof. In the production process of a cementitious slurry with or without fibers, it is preferred that the mixture is flowable during the mixing, pouring, and finishing and then becomes rigid for handling shortly after.

The cementitious mixture slurry can be applied to the polymer substrate in an amount of 0.4 g/in² or greater (e.g., 0.5 g/in² or greater, 0.6 g/in² or greater, 0.7 g/in² or greater, 0.8 g/in² or greater, or 0.9 g/in² or greater) on one or both sides of the polymer substrate.

The cementitious mixture can be cured after its application to the polymer substrate and can comprise air-drying, forced drying, cross-linking, curing chamber, and combinations thereof. In some embodiments, the mixture is cured for at least 48 hours (e.g. at least 60 hours, at least 72 hours, at least 84 hours, at least 96 hours, at least 108 hours, at least 120 hours, at least 132 hours, at least 144 hours, 156 hours, at least 168 hours). In some embodiments, the mixture is cured using any method and for any length of time necessary for the cementitious mixture to dry and adhere to the polymer substrate.

Various properties of the fibers in the cementitious mixture (e.g., fiber type, properties, ratios, etc. as disclosed herein) can be used to control the temperature upon completion of fiber dispersion and/or mixing time. In some embodiments, the time required for dispersing fibers into the cementitious mixture during mixing can be controlled by the diameter of the fiber. In some embodiments, a cementitious mixture comprising polymer fibers and glass fibers has a temperature upon completion of the dispersion of the polymer fibers and glass fibers during mixing as required to obtain a smooth surface upon application is controlled by the amount of fiber and/or the length of the fiber. In some embodiments, a cementitious mixture comprising glass fibers has a temperature upon completion of the dispersion of the polymer fibers and glass fibers during mixing as required to obtain a smooth surface upon application is controlled by the diameter of the fiber. In some embodiments, a cementitious mixture comprising glass fibers has a temperature upon completion of the dispersion of the polymer fibers and glass fibers during mixing as required to obtain a smooth surface upon application is controlled by the amount of fibers and/or length of the fibers.

Incorporation of the organic fiber into the first and second cementitious layers can influence on dispersability. In some embodiments, the addition of glass fibers of at least two different types allows the fibers to debundle more effectively and produce a smoother surface. In some embodiments, it is desirable that the composite material has a surface smoothness above a particular threshold at the desired loadings so it can be effectively processed. In some embodiments, the mix of organic fibers present in the composite material will include a first fiber type and a second fiber type. In some embodiments, the first fiber type and the second fiber type are present at a ratio of from 2:1 to 4:1 (e.g., 2:25:1, 2:5:1, 2.75:1, 3:1, 3.25:1, 3.5:1, 3.75:1). In some embodiments, the first fiber type and second fiber type will include glass fibers. In some embodiments, the glass fibers will include fiberglass. In some embodiments, the first fiber type will include ASTM D578 (2011) Type D/E or the like. In some embodiments, the second fiber type will include ASTM D578 (2011) Type G or the like.

In some embodiments, the polyurethane composite mixture described herein can be foamed. The polyol and the isocyanate can be allowed to produce a foamed polyurethane composite material after mixing the components according to the methods described herein. The polyurethane composite materials can be formed while they are actively foaming or after they have foamed. For example, the material can be placed under the pressure of a mold cavity prior to or during the foaming of the polyurethane composite material.

In some embodiments, incorporation of the organic fiber into the organic-inorganic composite material comprising an inorganic fiber or partial replacement of the inorganic fiber with an organic fiber can maintain similar or improved physical properties and mechanical performance such as flexural strength and handleability of such materials. Further, partial or full replacement of inorganic fibers by organic fibers can make the fiber system less susceptible to breaking and crushing during the production process of highly-filled polyurethane composites and thus increases the efficiency of fiber reinforcement.

In some embodiments, incorporation of the inorganic and/or organic fibers in a polymer substrate can increase the flexural strength of the organic-inorganic composite material, compared to an organic-inorganic composite material comprising a polyurethane composite without the fibers. The first cementitious layer and/or the second cementitious layer of the organic-inorganic composite material with organic and/or inorganic fibers can each comprises 15% less cement relative to the cementitious layer of the comparator organic-inorganic composite material with the same flexural strength and no fibers. The first cementitious layer and/or the second cementitious layer of the organic-inorganic composite material with two types of fibers disclosed herein can comprise 15% less cement relative to the cementitious layer of the comparator organic-inorganic composite material with the same flexural strength and one type of fibers. In some embodiments, the flexural strength of the organic-inorganic composite materials having fibers in one or more cementitious layers can be increased by at least 10%, for example, 15% or greater, 20% or greater, 25% or greater, 30% or greater, 35% or greater, 50% or greater, 75% or greater, or even 100% or greater, compared to an organic-inorganic composite without fibers. The flexural strength of the organic-inorganic composites described herein can be 200 psi or greater (e.g., 300 psi or greater, 400 psi or greater, 500 psi or greater, 600 psi or greater, 700 psi or greater, 800 psi or greater, 900 psi or greater, 1000 psi or greater, 1100 psi or greater, 1200 psi or greater, 1300 psi or greater, 1400 psi or greater, or 1500 psi or greater). In some embodiments, the organic-inorganic composites described herein can have a flexural strength of 1600 psi or less (e.g., 1550 psi or less, 1450 psi or less, 1350 psi or less, 1250 psi or less, 1200 psi or less, 1150 psi or less, 1050 psi or less, 950 psi or less, 850 psi or less, 750 psi or less, 650 psi or less, 550 psi or less, 450 psi or less, 350 psi or less, or 250 psi or less). For example, the flexural strength of the organic-inorganic composites can be 300 psi or greater, 500 psi or greater, 700 psi or greater, 900 psi or greater, 1000 psi or greater, 1 100 psi or greater, 1200 psi or greater, 1300 psi or greater, 1400 psi or greater, 1500 psi or greater, or 1600 psi or greater. The flexural strength can be determined by the load required to fracture a rectangular prism loaded in the three-point bend test as described in ASTM C1185-08 (2012).

In some embodiments, the smoothness of the organic-inorganic composite materials having fibers in one or more cementitious layers can be increased by at least 10%, compared to an organic-inorganic composite without fibers. The smoothness (or average roughness, Ra) can be determined, for example, by profilometry. In some embodiments, Ra can be determined by optical profilometry. Specifically, after curing the cementitious mixture to form a cementitious layer, a pictograph of a sample of the surface area of the cementitious layer can be obtained with a stereoscope (e.g., Nikon SMZ 1500) on 6.5× to 9.5× magnification. To show darker shadows in dips or valleys on the surface, and lighter shininess on peaks or bumps on the surface, at least one light source can be used to create an illumination across the surface area. In some embodiments, the at least one light source can be from 1″ to 3″ above the sample surface. In some embodiments, the at least one light source can be from 1″ to 5″ from the center of the sample surface. In some embodiments, the at least one light source can be at a 15° to 30° angle from the sample surface. Once the image is obtained, it can be evaluated using pixel classification software (e.g., Nikon NIS Elements' Pixel Classifier operation), to classify pixels into three categories based on intensity. Every pixel below an intensity value of 71 can be classified as Phase 1. These pixels represent the shadowy valleys. Every pixel above an intensity value of 96 can be classified as Phase 3. These pixels represent the lightened peaks. The pixels in between 71 and 96 can be classified as Phase 2 and represent the even, or level, areas between valleys and peaks. Once the pixel classification is set, it can be used for all samples evaluated for smoothness. The pixel classification software can automatically calculate the area percentage of each pixel classification. Using the percentage of Phase 2 pixels taken to describe the overall smoothness of the sample: a higher percentage indicates a surface with fewer valleys and peaks, while a lower percentage indicates a surface which is dimpled, or unsmooth.

In some embodiments, the modulus of the organic-inorganic composite materials having fibers in one or more cementitious layers (those cementitious layers comprising 15% less cement than a comparator cementitious layer without fibers) can be substantially the same as to an organic-inorganic composite without fibers. In some embodiments, the modulus of the organic-inorganic composite materials with fibers is 80 ksi or greater (e.g., 85 ksi or greater, 90 ksi or greater, 100 ksi or greater, 105 ksi or greater). In some embodiments, the modulus of the organic-inorganic composite materials with fibers is 110 ksi or less (e.g., 105 ksi or less, 100 ksi or less, 95 ksi or less, 90 ksi or less, 85 ksi or less). The modulus can be determined according to ASTM C947-03.

The properties, such as viscosity, flexural strength, handleability, and density of the composite allows their use in building materials and other structural applications. For example, the polyurethane composites can be formed into shaped articles before being coated with the cementitious mixture and used in building materials include siding materials, roofing materials such as roof coatings and roof tiles, claddings, architectural moldings, sheets, synthetic lumber, sound barrier/insulation, thermal barriers, insulation, fencing materials, component coatings, and other shaped articles. Examples of shaped articles made using composite materials described herein include roof tile shingles, trim boards, building panels, scaffolding, cast molded products, doors, door parts, moldings, sills, stone, masonry, brick products, posts, signs, guard rails, retaining walls, park benches, tables, slats, corner arches, columns, wall boards, ceiling tiles, ceiling boards, soffits, and railroad ties. The organic-inorganic composites described herein further can be used as reinforcement of composite structural members including building materials such as doors, windows, furniture, and cabinets and for well and concrete repair. The polyurethane composites can be flexible, semi-rigid or rigid foams. In some embodiments, the flexible foam is reversibly deformable (i.e., resilient) and can include open cells. An 8″×1″×1″ piece of a flexible foam can generally wrap around a 1″ diameter mandrel at room temperature without rupture or fracture. Flexible foams also generally have a density of less than 5 lb/ft³ (e.g., 1 lb/ft³ to 5 lb/ft³). In some embodiments, the rigid foam is irreversibly deformable and can be highly crosslinked and/or can include closed cells. Rigid foams generally have a density of 5 lb/ft³ or greater.

Various properties of the products made according to the present disclosure can be controlled by the type, amount, and/or properties of fibers incorporated into the cementitious mixture and/or polymer substrate. In some embodiments, the product's flexural mechanical properties can be controlled by the type of fibers added to the cementitious mixture on the polymer substrate, wherein the fiber type includes a mixture of inorganic fibers and organic fibers. In some embodiments, the product's flexural mechanical properties can be controlled by the diameter of the fibers added to the cementitious mixture on the polymer substrate. In some embodiments, the product's flexural mechanical properties can be controlled by the type of fibers added to the cementitious mixture on the polymer substrate, wherein the fiber type includes two different glass fiber types.

In some embodiments, the product's surface smoothness can be controlled by the type of the fibers added to the cementitious mixture on the polymer substrate, wherein the fiber type includes a mixture of inorganic fibers and organic fibers. In some embodiments, the product's surface smoothness can be controlled by the diameter of the fibers added to the cementitious mixture on the polymer substrate. In some embodiments, the product's surface smoothness can be controlled by the type of fibers added to the cementitious mixture on the polymer substrate, wherein the fiber type includes two different glass fiber types. In some embodiments, the product's surface smoothness can be controlled by the amount of fibers added to the cementitious mixture on the polymer substrate.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure.

### Example 1: Preparation of Cementitious Coated Composite Material Comprising Fibers of Differing Lengths

Three cementitious mixtures were applied on to two identical polymer substrates. One batch consisted of an ASTM D578 (2011) E-glass Fiber D/E with filaments of nominal diameter of 6 microns. The other batches consisted of a mixture of the D/E glass with Type G glass of two different lengths. Both Sample 1 and Sample 2 showed better debundling of glass fiber compared to the control batch. Details are in Table 2 below. The batching materials were mixed and poured onto the substrate. A smoothening edge was used to level the coating.

TABLE 2
Comparison of Inventive Compositions with
Fibers of Differing Lengths to Control

| Mix ID | Control | Sample 1 | Sample 2 |
|---|---|---|---|
| Batching Materials | | | |
| Cement Weight, g | 500 | 500 | 500 |
| Ordinary Portland | 400 | 400 | 400 |
| Cement, Type 1, g | | | |
| Calcium | 100 | 100 | 100 |
| Sulfoaluminate | | | |
| Cement, g | | | |
| Water, g | 200 | 200 | 200 |
| Superplasticizer, g | 1.25 | 1.25 | 1.25 |
| Viscosity Modifier, g | 1.25 | 1.25 | 1.25 |
| Chopped Fiberglass | 5.00 | 3.75 | 3.75 |
| ¼″ length, ASTM | | | |
| Type D/E, g | | | |
| Chopped Fiberglass | 0.00 | 1.25 | 0.00 |
| ⅛″ length, Type G, g | | | |
| Chopped Fiberglass | 0.00 | 0.00 | 1.25 |
| 4.2 mm length, | | | |
| ASTM Type G, g | | | |
| Curing Info | | | |
| Cure Time, days | 7 | 7 | 7 |
| Cure Temperature | Room | Room | Room |
| Condition | Temperature | Temperature | Temperature |
| Cure Humidity Condition | Atmosphere | Atmosphere | Atmosphere |
| Mechanical Properties | | | |
| Cement Coating | 0.63 | 0.53 | 0.55 |
| Applied to Substrate, | | | |
| g/in² per side | | | |
| Flex Strength, psi | 365 | 347 | 342 |
| Substrate Modulus, ksi | 14 | 15 | 15 |
| Modulus, ksi | 110 | 101 | 92 |
| Fiber debundling | Partial | Effective | Effective |

As shown in Table 2 above, using a mixture of glass fibers results in more effective debundling of the glass fiber bundles. As shown above in Table 2, the type of fibers used has a strong influence on dispersibility. The inventors surprisingly found that the addition of a mixture of glass fibers of two different lengths allows the fibers to debundle more effectively and thus produce a smoother surface.

### Example 2: Preparation of Cementitious Coated Composite Material Comprising Fibers of Different Types

Two cementitious mixtures were applied on two identical polymer substrates. One batch consisted of an ASTM D578 (2011) E-glass Fiber D/E with filaments of nominal diameter of 6 microns. The other batch consisted of a mixture of the glass fiber and a polyester fiber. Results for flexural mechanical properties are shown in Table 3 below. The batching materials were mixed and poured onto the substrate.

TABLE 3
Comparison of Inventive Composition with
Fibers of Differing Types to Control

| Mix ID | Control | Sample 1 |
|---|---|---|
| Batching Materials | | |
| Ordinary Portland | 400 | 400 |
| Cement, Type 1, g | | |
| Calcium Sulfoaluminate | 100 | 100 |
| Cement, g | | |
| Water, g | 200 | 200 |
| Superplasticizer, g | 1.5 | 1.5 |
| Viscosity Modifier, g | 1.25 | 1.25 |
| Chopped Fiberglass, g | 5.00 | 5.00 |
| Polyester Fiber, g | 0.00 | 1.25 |
| Curing Info | | |
| Cure Time, days | 7 | 7 |
| Cure Temperature | Room | Room |
| Condition | Temperature | Temperature |
| Cure Humidity | Atmosphere | Atmosphere |
| Condition | | |
| Mechanical Properties | | |
| Cement Mixture | 0.63 | 0.54 |
| Applied to Substrate, | | |
| g/in² per side | | |
| Flexural Strength, psi | 365 | 348 |
| Modulus, ksi | 110 | 123 |

As shown in the table above, using a polymer fiber in addition to glass fiber results in a higher flexural modulus compared to products made with only glass fiber. As shown herein in Table 3, the type of fibers can have a strong influence on the mechanical properties. The inventors surprisingly found the addition of a mixture of organic and inorganic fibers provides a higher modulus or stiffening to the composite compared to a product with only inorganic fibers. Further, the use of only polymer fibers results in lower flexural strength. Thus, a mixture of polymer fibers and glass fibers provide improved mechanical properties.

### Example 3: Preparation of Cementitious Coated Composite Material Comprising Fibers of Higher Diameter

Two cementitious mixtures were applied on two identical polymer substrates. One batch consisted of an ASTM D578 (2011) E-glass Fiber M with filaments of nominal diameter of 16 microns. The other batch consisted of an ASTM D578 (2011) E-glass Fiber D/E with filaments of nominal diameter of 6 microns. Results for flexural mechanical properties are shown in Table 4 below. The batching materials were mixed and poured onto the substrate. A smoothening edge was used to level the coating.

TABLE 4
Comparison of Inventive Composition with
Fibers of Higher Diameter to Control

| Sample | 1 | 2 |
|---|---|---|
| Ordinary Portland Cement, g | 99 | 99 |
| Fiber M E-Fiber Glass ¼″ chop length, | 1 | |
| 16 micron diameter, g | | |
| Fiber D/E E-Fiber Glass ¼″ chop length, | | 1 |
| 6 micron diameter, g | | |
| Debundling efficiency during mixing, relative time | Short | Long |
| required | mixing | Mixing |
| Surface smoothness, relative | Good | Fair |
| Flexural Strength, psi | 372 | 280 |
| Flexural Modulus, ksi | 198 | 164 |

As shown in Table 4 above, using a larger diameter fiber results in higher flexural strength and flexural modulus compared to products made with lesser diameter fiber. As also shown in Table 4 above, larger diameter fibers were easier to debundle during the mixing process, resulting in less heat generation during mixing. In addition, as also shown in the table above, the surfaces of composites coated with cementitious mixtures containing larger diameter fibers is relatively smoother than surfaces coated with cementitious mixture containing finer diameter fibers. As shown herein, the diameter of glass fiber filaments has a strong influence on the mechanical properties. The inventors surprisingly found that, for the same weight fraction of fibers and to the same weight of cementitious matrix, the larger the diameter of the fiber, the higher is the strength. The larger diameter of glass fiber leads to a lesser total length of fiber strands compared to an equal weight of finer diameter fibers. In spite of the lower total length of larger diameter fibers in the same weight of cementitious matrix, the mechanical properties of the coarser diameter fiber are improved compared to the mechanical properties obtained using the finer diameter fine fibers.

### Example 4

A polyurethane core having an average density 12.94 pcf was coated with a cementitious mixture comprising 500 g CSA cement, 225 g water, 1.75 g methylcellulose (e.g., as a viscosity modifying agent) and fibers of the type and amount shown in the following Table. The resulting composite density and smoothness % are also shown in the following Table 5. The batching materials were mixed and poured onto the substrate. The mixture was then cured for at least 48 hours. Samples were then tested for smoothness in accordance with the method described above. Specifically, a pictograph of a 1″×1″ surface area of each sample was obtained with a Nikon SMZ 1500 stereoscope on 7.5× magnification. A single light source was used 1.5″ above the sample surface, 3″ from the center of the sample area, and at a 20° angle from the sample surface, in order to create the desired illumination across the surface area. Once the image was obtained, it was evaluated using the Nikon NIS Elements software. Using the Pixel Classifier operation, pixels were classified into three categories based on intensity. Every pixel below an intensity value of 71 was classified as Phase 1. These pixels represent the shadowy valleys. Every pixel above an intensity value of 96 was classified as Phase 3. These pixels represent the lightened peaks. The pixels in between 71 and 96 were classified as Phase 2 and represent the even, or level, areas between valleys and peaks. Once the pixel classification was set, it was used for all samples evaluated for smoothness. The Pixel Classifier automatically calculated the area percentage of each pixel classification. The percentage of Phase 2 pixels was taken to describe the overall smoothness of the sample: a higher percentage indicating a surface with fewer valleys and peaks, and a lower percentage indicating a surface which is very dimpled, or unsmooth. The resulting smoothness % is shown in the following Table 5 along with the composite density of each sample.

TABLE 5
Comparison of Organic-inorganic Composite Materials

| | Chopped Fiberglass | Chopped Fiberglass | Chopped Fiberglass | Chopped Fiberglass | Chopped Fiberglass | | |
|---|---|---|---|---|---|---|---|
| | (5.0-7.6 | (5.0-7.6 | (5.0-7.6 | (9.0-10.2 | (15.2-16.5 | | |
| | micron diameter, | micron diameter, | micron diameter, | micron diameter, | micron diameter, | Composite | |
| | 3.18 mm length) | 6.35 mm length) | ½ in. length) | 6.35 mm length) | 6.35 mm length) | Density | Smoothness |
| | grams | grams | grams | grams | grams | g/cm³ | % |
| 1 | 0 | 5 | 0 | 0 | 0 | 0.37 | 63 |
| 2 | 0 | 0 | 0 | 5 | 0 | 0.40 | 74 |
| 3 | 0 | 0 | 0 | 0 | 5 | 0.41 | 85 |
| 4 | 5 | 0 | 0 | 0 | 0 | 0.39 | 65.7 |
| 5 | 0 | 5 | 0 | 0 | 0 | 0.37 | 63.3 |
| 6 | 0 | 0 | 5 | 0 | 0 | 0.35 | 62.9 |
| 7 | 2.5 | 0 | 0 | 0 | 0 | 0.43 | 81.3 |
| 8 | 5 | 0 | 0 | 0 | 0 | 0.39 | 65.7 |
| 9 | 7.5 | 0 | 0 | 0 | 0 | 0.41 | 42.8 |
| 10 | 0 | 5 | 0 | 0 | 0 | 0.39 | 65.7 |
| 11 | 1.25 | 3.75 | 0 | 0 | 0 | 0.40 | 64.2 |
| 12 | 2.5 | 2.5 | 0 | 0 | 0 | 0.36 | 67.6 |
| 13 | 3.75 | 1.25 | 0 | 0 | 0 | 0.36 | 70.3 |
| 14 | 5 | 0 | 0 | 0 | 0 | 0.37 | 63.3 |
| 15 | 0 | 0 | 0 | 0 | 5 | 0.37 | 63.3 |
| 16 | 0 | 1.25 | 0 | 0 | 3.75 | 0.28 | 66.4 |
| 17 | 0 | 2.5 | 0 | 0 | 2.5 | 0.34 | 68.2 |
| 18 | 0 | 3.75 | 0 | 0 | 1.25 | 0.33 | 70.5 |
| 19 | 0 | 5 | 0 | 0 | 0 | 0.41 | 84.8 |

Samples 1-3 show the composite densities and smoothness for three samples that differ in their fiber diameters. As the fiber diameters increased in the samples, the composite densities increased from 0.37 g/cm³ to 0.41 g/cm³ and the smoothness % increased from 63% to 85%. Samples 4-6 show the composite densities and smoothness for three samples that differ in their fiber lengths. As the fiber lengths increased in the samples, the composite densities decreased from 0.39 g/cm³ to 0.35 g/cm³ and the smoothness % decreased from 65.7% to 62.9%. Samples 7-9 show the composite densities and smoothness for three samples that differ in the amount of fiber present. As the amount of fiber present increases, the composite densities were at 0.43, 0.39, and 0.41, and the smoothness percentages were at 81.3%, 65.7%, and 42.8%. The 5-gram sample (sample 8) had the lowest density of samples 7-9 and the middle smoothness percentage. Samples 10-14 show the composite densities and smoothness, with two samples having only one fiber type and three samples having a mixture of two fiber types. The samples with only one fiber type (samples 10 and 14) have composite densities ranging from 0.37 g/cm³ to 0.39 g/cm³, while the samples with two fiber types of the same diameter but different lengths (samples 11-13) have composite densities ranging from 0.36 g/cm³ to 0.40 g/cm³. The samples with only one fiber type (samples 10 and 14) have smoothness ranging from 63.3% to 65.7%, while the samples with two fiber types of the same diameter but different lengths (samples 11-13) have smoothness ranging from 64.2% to 70.3%. The lowest density and highest smoothness of samples 10-14 is with samples with two fiber types. Samples 15-19 show the composite densities and smoothness, with two samples having only one fiber type and three samples having two fiber types. The samples with only one fiber type (samples 15 and 19) have composite densities ranging from 0.37 g/cm³ to 0.40 g/cm³, while the samples with two fiber types of the same length but different diameters (samples 16-18) have smoothness ranging from 66.4% to 70.5%. The inventors found that low density and high smoothness can be advantageous to keep the weight of the product down while imparting desirable mechanical properties, durability, and aesthetic finish. The inventors found that sample 18, for instance, has a low density and high smoothness (e.g., density of 0.33 g/cm³ and smoothness of 70%).

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily used as a basis for the design of other structures, methods, and systems for carrying out the several purposes of the embodiments and claims presented in this application. It is important, therefore, that the claims be regarded as including such equivalent constructions.

1. An organic-inorganic composite material comprising:
a first cementitious layer comprising a first inorganic fiber, a first organic fiber, or a mixture thereof;
a second cementitious layer comprising a second inorganic fiber, a second organic fiber, or a mixture thereof;
a composite core having a first planar surface and a second planar surface opposite the first planar surface;
wherein the first cementitious layer is in physical communication with the first planar surface, and
wherein the second cementitious layer is in physical communication with the second planar surface.

2-5. (canceled)

6. The organic-inorganic composite material of claim 1, wherein the first fiber type is from 0.20 inches in length to 10 inches in length.

7. The organic-inorganic composite of claim 1, wherein the second fiber type is from 0.10 inches in length to 55 inches in length.

8-12. (canceled)

13. The organic-inorganic composite material of claim 1, having a flexural strength of 300 psi or greater.

14. (canceled)

15. The organic-inorganic composite material of claim 1, having a modulus of 80 ksi to 110 ksi.

16. (canceled)

17. The organic-inorganic composite material of claim 1, wherein the composite core comprises a polyurethane composite core.

18-30. (canceled)

31. An organic-inorganic composite material comprising:
a first cementitious layer comprising a plurality of fibers having an average diameter of 7 microns or greater; and
a composite core having a first planar surface and formed by the reaction of at least one isocyanate selected from the group consisting of diisocyanates, polyisocyanates and mixtures thereof and at least one polyol in the presence of an inorganic filler;
wherein the first cementitious layer is in physical communication with the first planar surface of the composite core.

32. An organic-inorganic composite material comprising:
a first cementitious layer comprising a first plurality of fibers having an average diameter of 7 microns or greater;
a second cementitious layer comprising a second plurality of fibers having an average diameter of 7 microns or greater; and
a composite core formed by the reaction of at least one isocyanate selected from the group consisting of diisocyanates, polyisocyanates and mixtures thereof and at least one polyol in the presence of an inorganic filler;
wherein the first cementitious layer is in physical communication with a first planar surface, and
wherein the second cementitious layer is in physical communication with a second planar surface.

33. The organic-inorganic composite material of claim 31, further comprising a second cementitious layer, wherein the composite core comprises a second planar surface opposite the first planar surface in physical communication with the first cementitious layer, and wherein the second cementitious layer is in physical communication with the second planar surface of the polyurethane core.

34. (canceled)

35. The organic-inorganic composite material of claim 31, wherein the first fiber type is from 0.20 inches in length to 10 inches in length.

36. (canceled)

37. The organic-inorganic composite material of claim 31, having a flexural strength of 300 psi or greater.

38. (canceled)

39. The organic-inorganic composite material of claim 32, having a modulus of 200 ksi.

40. (canceled)

41. The organic-inorganic composite material of claim 1, wherein the inorganic filler comprises fly ash from 5% wt. to 95% wt. of the composite core.

42. (canceled)

43. The organic-inorganic composite material of claim 1, wherein the first and second fiber types further comprise inorganic fibers, polymer fibers, natural fibers, or combinations thereof.

44-54. (canceled)

55. The organic-inorganic composite material of claim 43, wherein the first and second fiber types comprise glass fibers or basalt fibers.

56. The organic-inorganic composite material of claim 43, wherein the first and second fiber types comprise polyester, nylon, aramid, polypropylene, polycarbonate, or a combination thereof.

57. The organic-inorganic composite material of claim 43, wherein the first and second fiber types comprise coir, hemp, cellulose, wool, hair, feathers, husks, or a combination thereof.
